(19) United States
(12) Patent Application Publication
(10) Pub. No.: US 2003/0012173 A1
(43) Pub. Date: Jan. 16, 2003

(54) Coordinated inquiry and page procedures in an ad-hoc wireless network

(76) Inventor: Johan Rune, Lidingo (SE)

Correspondence Address: Ronald L. Grudziecki, BURNS, DOANE, SWECKER & MATHIS, L.L.P., P.O. Box 1404, Alexandria, VA, 22313-1404, US

(21) Appl. No.: 10/042,000

(22) Filed: Oct. 25, 2001

Related U.S. Application Data
(60) Provisional application No. 60/246,606, filed on Nov. 8, 2000.

(51) Int. Cl. H04J 3/16

(52) U.S. Cl. 370/344; 370/465

(57) ABSTRACT

A method for coordinating network nodes in a network includes informing a first slave node, by a master node, of a first period to scan for inquiry messages and informing a second slave node, by the master node, of a second period for scanning for inquiry messages. The first period and second period do not occur during the same period of time. The first slave node scans for inquiry messages during the first period. The second slave node scans for inquiry messages during the second period. The second node sends an inquiry response message to the first node, the message including page scan information which indicates parameters related to a scanning for page messages by the second node. The first node pages the second node in accordance with the page scan information. The parameters include timing and frequency information related to the scanning for page messages by the second node.

### CROSS-REFERENCE TO RELATED APPLICATION

This application is related to, and claims priority from, U.S. Provisional Application No. 60/246,606 entitled “Co-Ordinated Inquiry and Page Procedures” filed on Nov. 8, 2000, the disclosure of which is incorporated herein by reference.

### BACKGROUND

The present invention is related to ad-hoc wireless network communication, and more particularly to an efficient procedure for establishing and maintaining general connectivity among nodes in an ad-hoc wireless network.

Recently, a radio interface referred to as Bluetooth was introduced to provide wireless, ad hoc networking between mobile phones, laptop computers, headsets, PDAs, and other electronic devices. Some of the implementation details of Bluetooth are disclosed in this application, while a detailed description of the Bluetooth system can be found in “BLUETOOTH—The universal radio interface for ad hoc, wireless connectivity,” by J. C. Haartsen, Ericsson Review No. 3, 1998. Further information about the Bluetooth interface is available on the Official Bluetooth Website on the World Wide Web at http://www.bluetooth.org.

Bluetooth was initially developed to eliminate cables between phones, PC-cards, wireless headsets, etc., but has evolved into an ad-hoc wireless network technology intended for both synchronous traffic, such as voice based traffic, and asynchronous traffic, such as IP based data traffic. Bluetooth promises to provide the ability for any commodity device, such as telephones, PDAs, laptop computers, digital cameras, video monitors, printers, fax machines, to be able to communicate via a radio interface. The commodity devices must contain a Bluetooth radio chip and associated software.

Bluetooth is a wireless communication technology operating in the unlicensed 2.4 GHz ISM (Industrial, Scientific, and Medical) band using a fast frequency-hopping scheme to minimize interference with non-Bluetooth sources. The frequency-hopping occurs nominally at 1,600 hops per second. The system typically has 79 possible channels (the spectrum allocation in some countries only allow the use of 23 of the frequencies), with a typical channel spacing of 1 MHZ. Two or more Bluetooth (BT) units sharing the same channel form a piconet, as illustrated in FIG. 1. Each BT unit in a piconet may perform the functions of either a master or slave. Within each piconet there is always exactly one master and up to seven active slaves. Any BT unit can perform the functions of a master in a piconet.

Furthermore, two or more piconets can be wirelessly interconnected to form a scatternet, as illustrated in FIG. 2. The connection point between the two piconets consists of a BT unit that is a member of both piconets. A BT unit can simultaneously be a slave member of multiple piconets. However, a BT unit may only be a master in one piconet at a time, but may simultaneously participate as a slave in other piconets. A BT unit may only transmit and receive data in one piconet at a time, so participation in multiple piconets is done on a time division multiplex basis.

The Bluetooth system provides full-duplex transmission built on slotted Time Division Duplex (TDD), where each slot is 0.625 ms long. The time slots are cyclically numbered sequentially using a large cycle of 2²⁷. Master-to-slave transmission always starts in an even-numbered time slot, while slave-to-master transmission always starts in an odd-numbered time slot. An even-numbered master-to-slave time slot and its subsequent odd-numbered slave-to-master time slot together comprise a frame, except when multi-slot packets are used. There is no direct transmission between slaves in a Bluetooth piconet, only between master and slave and vice versa.

Communication within a piconet is organized so that the master polls each slave according to a polling scheme. A slave typically transmits after being polled by the master, with minor exceptions described below. The slave starts its transmission in the slave-to-master time slot immediately following the packet received from the master. The master may or may not include data in the packet used to poll a slave. The only exception to the above principle is that when a slave has an established Synchronous Connection Oriented (SCO) link, which is described further below, the slave may continue to transmit in the pre-allocated slave-to-master time slot, even if not explicitly polled by the master in the preceding master-to-slave time slot.

A globally unique 48 bit IEEE 802 address, called the Bluetooth Device Address (BD_ADDR), is assigned to each BT unit at the time of manufacture, and it is never changed. In addition, the master BT of a piconet assigns a local Active Member Address (AM_ADDR) to each active member of the piconet. The AM_ADDR, which is only three bits long and is assigned and cleared dynamically, is unique only within a single piconet. The master uses the AM_ADDR when polling a slave in a piconet. However, when the slave transmits a packet to the master, in response to a packet received from the master, the slave includes its own AM_ADDR in the packet header, not the master's.

When forming or reforming a Bluetooth scatternet, the BT units use INQUIRY and PAGE procedures to discover and establish a connection with neighboring BT units. The INQUIRY procedure enables a BT unit to discover which units are in range, and what their device addresses and clocks are. A PAGE procedure is used by the master BT unit to establish a connection with a slave BT unit.

FIG. 3 illustrates a state diagram of a BT unit link controller. Standby 10 is the default state of the BT unit. In the Page Scan 30 substate, a unit listens for its own device access code (DAC), which is derived from the unit's BD_ADDR, for the duration of a scan window at a single hop frequency. The scan window is long enough for a paging device to page at 16 page frequencies. The Page Scan 30 substate can be entered from the Standby 10 state or the Connection 90 state. In the Standby 10 state, no connection has been established and the unit can use all the capacity to carry out the Page Scan 30. Before entering the Page Scan 30 substate from the Connection 90 state, the unit reserves a significant amount of capacity for scanning.

The Page 20 substate is used by the master BT unit (source) to activate and connect to a slave BT unit (destination) which periodically wakes up in the Page Scan 30 substate. The master tries to capture the slave by repeatedly transmitting the slave's DAC in different hop channels. Since the Bluetooth clocks of the master and the slave are not synchronized, the master does not know exactly when the slave wakes up and on which hop frequency. Therefore, it transmits a train of identical DACs at different hop frequencies, and listens in between the transmit intervals until it receives a response from the slave. The Page 20 substate can be entered from the Standby 10 state or the Connection 90 state. In the Standby 10 state, no connection has been established and the unit can use all the capacity to carry out the Page 20. Before entering the Page Scan 30 substate from the Connection 90 state, the unit reserves a significant amount of capacity for scanning.

An inquiry procedure is used in applications where the destination's BD_ADDR is unknown to the source. Alternatively, the inquiry procedure can be used to discover if other BT units are within range. During the Inquiry 50 substate, the discovering unit collects the BT device addresses and clocks of all units that respond to the inquiry message. The discovering unit can then, if desired, establish a connection to any one of them using the page procedure. The inquiry message broadcast by the source does not contain any information about the source. However, it may indicate which class of devices should respond. There is one general inquiry access code (GIAC) to inquire for any Bluetooth device, and a number of dedicated inquiry access codes (DIAC) that only inquire for a certain type of devices.

A BT unit that wants to discover other BT units enters the Inquiry 50 substate. In this substate, it continuously transmits the inquiry message at different hop frequencies. A unit that allows itself to be discovered, regularly enters the Inquiry Scan 40 substate to respond to inquiry messages. The inquiry response is optional: a unit is not forced to respond to an inquiry message.

The more efficient the INQUIRY and PAGE procedures are, the faster the neighbor discovery and connection establishment functions can be performed. Additionally, while the INQUIRY and PAGE procedures are performed, the BT unit's other tasks are preferably minimally inhibited. That is, the procedures should consume as little as possible of a device's resources, such as processing time and battery power. These two requirements are, to a certain extent, contradictory, and must be balanced. Smart mechanisms and good trade-offs must be developed to satisfactorily meet both requirements. This is particularly important when the INQUIRY and PAGE procedures are part of an overall process to establish and maintain connectivity among a number of nodes in the vicinity of each other, for example during the formation and maintenance of a Maximum Connectivity Scatternet, as described in copending U.S. patent application No. 09/876,087, entitled “Efficient Scatternet Forming,” Per Johansson et al., filed Jun. 8, 2001 (“Efficient Scatternet Forming”).

Typically, an idle (i.e., unconnected) BT unit establishes connectivity with a BT unit in an existing scatternet that is busy performing various other tasks, such as internally supporting applications and communicating with other BT units, or even forwarding packets on behalf of other BT units. These activities are interrupted to perform conventional INQUIRY/INQUIRY SCAN and PAGE/PAGE SCAN procedures.

More efficient procedures are needed to minimize these interruptions. Several problems must be addressed to implement a more efficient INQUIRY/INQUIRY SCAN and PAGE/PAGE SCAN procedures. One problem to address is how to send an INQUIRY message simultaneously with, and at the same frequency as, a neighboring connected BT unit performing an INQUIRY SCAN. Another problem is enabling an idle BT unit to page one of the BT units that responded to the INQUIRY message while simultaneously performing PAGE SCAN procedures, and at the same frequency, when one or more neighboring connected BT units are found through the INQUIRY procedure. After establishing a connection with a connected BT unit, the previously idle BT unit may want to page the paged BT unit's master. This also presents a problem, since the master is probably the busiest node in a piconet, making the masters resources the most valuable. However, since connectivity with the scatternet is now established, the new BT unit may schedule a time for a PAGE procedure with the master, provided that such a mechanism is supported.

Accordingly, a procedure is needed for efficient connectivity establishment between BT units with minimal disturbance of other BT unit activities.

### SUMMARY

The present INQUIRY and PAGE procedures are too inefficient to be acceptable, especially for Bluetooth units that are already connected to a piconet or a scatternet. Too much time and resources are taken away from other tasks, such as communication with other units or forwarding packets on behalf of other units. The INQUIRY and PAGE procedures must be efficient to enable fast neighbor discovery and connection establishment, while at the same time using as little as possible of the participating units' time and resources. Hence, improvements of both the INQUIRY procedure and the PAGE procedure are addressed herein.

Generally speaking, a two part solution is described. The coordination of INQUIRY and INQUIRY SCAN periods within a piconet, controlled by the master, is described. The precise scheduling of PAGE SCAN periods, giving potential paging devices detailed information in the INQUIRY RESPONSE message about what time to PAGE and what frequency to use, is also described.

When coordinating the INQUIRY SCAN periods of the nodes in the piconet, the master preferably coordinates the periods to have at least one device in the INQUIRY SCAN state at any one time. This may not be possible, but a consequence of this goal is that the INQUIRY SCAN periods are distributed among the slaves in the piconet and, in general, overlapping periods are avoided. The master itself may or may not share the burden of INQUIRY SCANS with its slaves.

The master may also schedule INQUIRY state periods for its slaves, along with instructions to either PAGE the responding units when certain default conditions apply or report the responses to the master. This concerns INQUIRY messages with the purpose of establishing and maintaining general connectivity, e.g., using a special Connectivity Inquiry Access Code (“Connectivity IAC”).

When assigning INQUIRY SCAN periods or INQUIRY periods to its slaves, the master preferably sends this signaling data packets that are transmitted for other purposes, e.g., user data packets, using a technique known as piggybacking. Details of a possible piggybacking technique can be found in a commonly assigned U.S. Utility patent application entitled “In-band Signaling,” by Johan Rune and Martin van der Zee, filed Oct. 9, 2001, docket number 040071-819 (“In-band Signaling”), which is hereby incorporated by reference.

The present invention addresses these and other concerns. According to one aspect, a method for coordinating network nodes in a network includes a master node informing a first slave node of a first period to scan for inquiry messages. The master node informs a second slave node of a second period for scanning for inquiry messages, wherein the first period and second period do not occur during a same period of time. The first slave node scans for inquiry messages during the first period, wherein an inquiry message is used by a node sending the inquiry message to determine which nodes are reachable by the node sending the inquiry message.

According to another aspect, a method for coordinating network nodes in a network includes a master node informing a first slave node of a first period to send an inquiry message. The master node informs a second slave node of a second period for sending an inquiry message, wherein the first period and second period do not occur during a same period of time. The first slave node sends an inquiry message during the first period, wherein the inquiry message is used by the first node to determine which nodes are reachable by the first node.

According to yet another aspect, a method for coordinating establishment of a connection between network nodes in a network includes sending an inquiry message from a first node to a second node. The second node sends an inquiry response message to the first node, wherein the inquiry response message includes page scan information which indicates parameters related to a scanning for page messages by the second node. The first node pages the second node in accordance with the page scan information.

According to yet another aspect, a method for coordinating establishment of a connection between network nodes in a network includes sending an inquiry message from a first node to a second node. The second node sends an inquiry response message to the first node, wherein the inquiry response message includes page scan information which indicates parameters related to a scanning for page messages by a master node associated with the second node. The first node pages the master node in accordance with the page scan information.

According to yet another aspect, a method for coordinating network nodes in a network includes a first master node informing a first slave node of a first period to scan for inquiry messages. A second master node informs a second slave node of a second period for sending inquiry messages. The first slave node scans for inquiry messages during the first period. The second slave node sends an inquiry message during the second period. The first slave node sends an inquiry response message to the second slave node, wherein the inquiry response message includes page scan information that indicates parameters related to a scanning for page messages by the first node. The second slave node pages the first slave node in accordance with the page scan information. The first slave node responds to the page, thereby establishing a connection between the first slave node and the second slave node.

According to yet another aspect, a device for coordinating network nodes in a network includes means for informing a first slave node of a first period to scan for inquiry messages and means for informing a second slave node of a second period for scanning for inquiry messages, wherein the first period and second period do not occur during a same period of time. An inquiry message is used by a node sending the inquiry message to determine which nodes are reachable by the node sending the inquiry message.

According to yet another aspect, a device for coordinating establishment of a connection between network nodes in a network includes means for sending an inquiry message to a node of the network and means for receiving an inquiry response message from the node at the device, wherein the inquiry response message includes page scan information which indicates parameters related to a scanning for page messages by the node. The device also includes means for paging from the device to the node in accordance with the page scan information.

### BRIEF DESCRIPTION OF THE DRAWINGS

The above and other objects, features, and advantages of the present invention will become more apparent in light of the following detailed description in conjunction with the drawings, in which like reference numerals identify similar or identical elements, and in which:

FIG. 1 is a diagram illustrating various piconet configurations;

FIG. 2 is a diagram illustrating a scatternet;

FIG. 3 is a state diagram of a BT unit link controller;

FIG. 4 is a table of scheduling properties resulting from different combinations PAGE SCAN timing parameter size and time unit according to the present invention;

FIG. 5 is a diagram illustrating the format of an FHS packet;

FIG. 6 is a diagram illustrating the format of an FHS packet showing available bits as a contiguous block according to the present invention;

FIG. 7 is a diagram illustrating the format of the available bit block in a preferred alternative of the two-device-case when a scatternet identity is used according to the present invention;

FIG. 8 is a diagram illustrating the format of the available bit block in a preferred alternative of the two-device-case when no scatternet identity is used according to the present invention;

FIG. 9 is a diagram illustrating various sizes for an available bit block (30, 46, and 74 bits) in the single-device-case according to the present invention;

FIG. 10 is a diagram illustrating the format of the available bit block in a preferred alternative of the only-single-device-case-scenario and the topological-status-case and the responding-page-scan-mode-case of the dynamic-single-device-case-scenario when a scatternet identity is used according to the present invention;

FIG. 11 is a diagram illustrating the format of the available bit block in a preferred alternative of the only-single-device-case-scenario and the topological-status-case and the responding-page-scan-mode-case of the dynamic-single-device-case-scenario when no scatternet identity is used according to the present invention;

FIG. 12 is a table of preferred alternatives for different cases, scenarios, and sub-cases according to the present invention; and

FIG. 13 is a flow diagram describing the procedure followed by an inquiring unit when receiving an INQUIRY RESPONSE message.

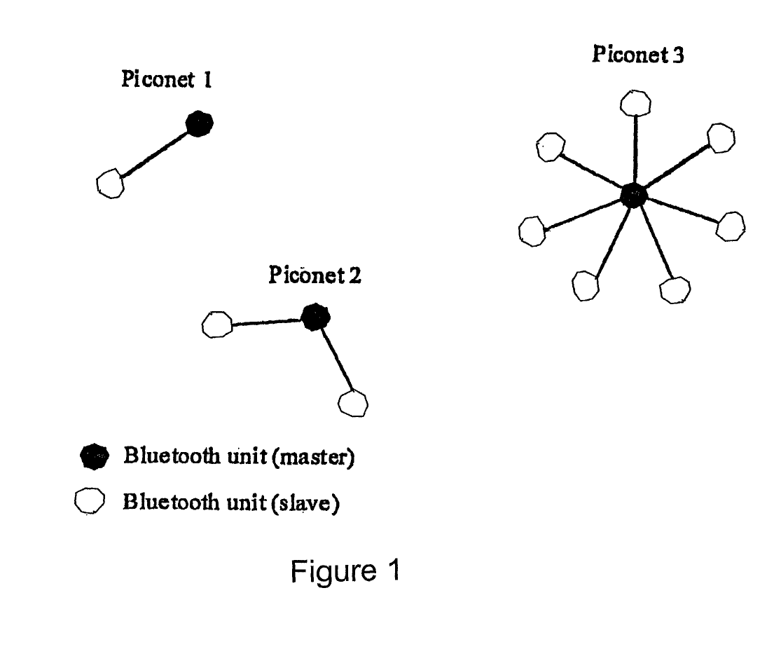

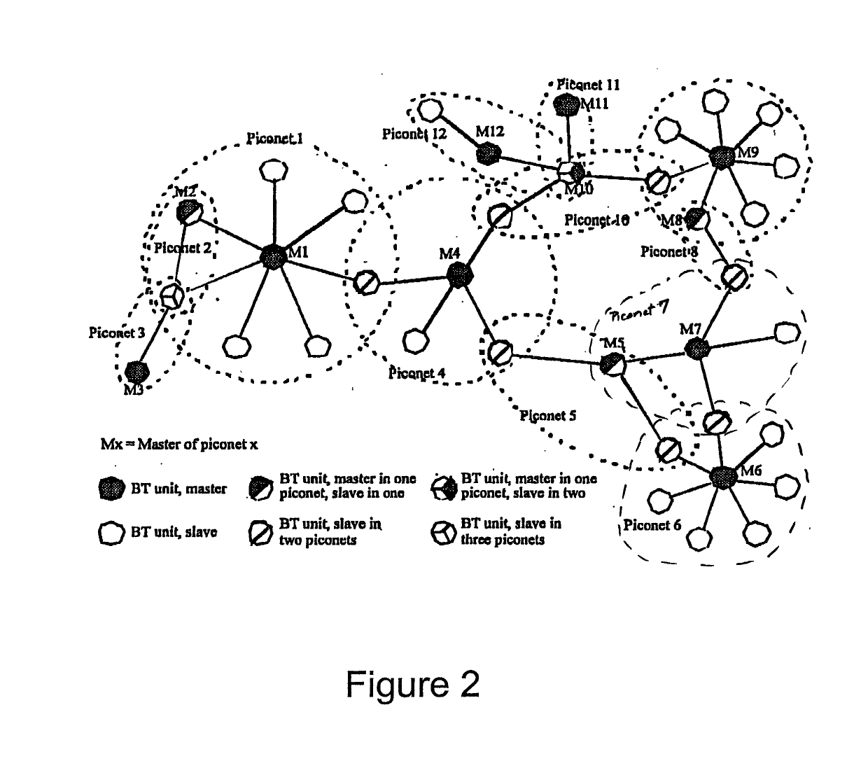

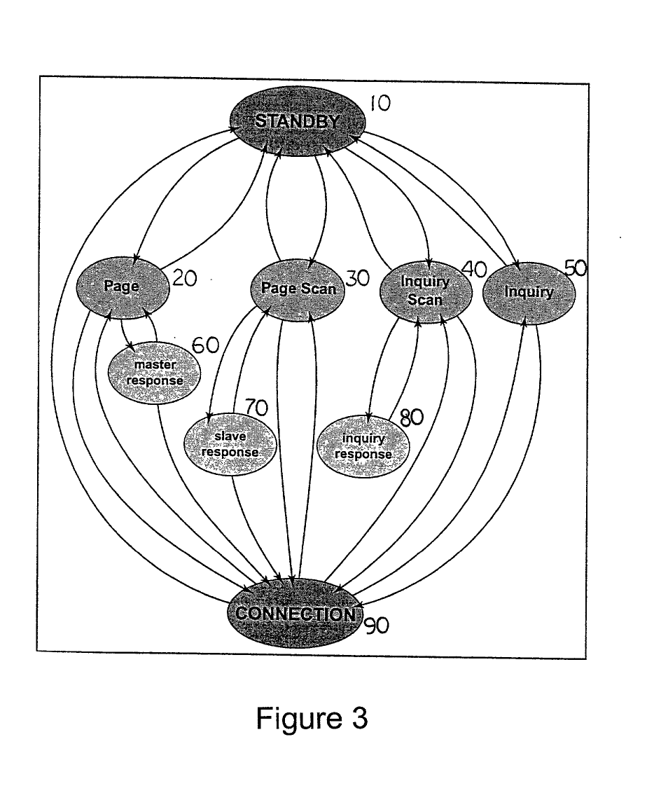

### DETAILED DESCRIPTION

Preferred embodiments of the present invention are described below with reference to the accompanying drawings. In the following description, well-known functions and/or constructions are not described in detail to avoid obscuring the invention in unnecessary detail.

To make the most efficient use of each BT unit's resources, such as processing time and battery power, communicating BT units within a piconet achieve a mutual coordination of INQUIRY and INQUIRY SCAN procedures.

The master is responsible for coordinating the INQUIRY SCAN periods and the INQUIRY periods of the nodes within a piconet. In this context the coordination of INQUIRIES may be limited to “Connectivity INQUIRIES.” The Connectivity INQUIRIES use a special connectivity inquiry access code (CIAC), which requires a specific kind of INQUIRY RESPONSE from responding BT units. Alternatively, standard INQUIRIES may be used, using the General IAC (GIAC), but with the specific purpose of increasing the general connectivity between nodes in the vicinity. The term INQUIRY is used below in a general sense to denote either case.

The master issues a request to a slave to enter the INQUIRY SCAN mode a single time or according to a periodic schedule. In this way, the master can organize the cumulative, or compound, INQUIRY SCAN periods of all the nodes in the piconet to minimize the gaps between, and to avoid overlaps in, INQUIRY SCAN periods of different nodes. Organized INQUIRY SCAN periods increase the likelihood of an external node (i.e., idle, connected to another scatternet, or connected to another piconet within the same scatternet) getting in contact with the piconet, even when the external node is not within radio reach of all the nodes in the piconet.

For maximum resource efficiency, the INQUIRY SCAN requests are preferably carried from the master in packets that are transmitted for other purposes, e.g., user data packets, using a technique known as piggybacking. Details of one possible piggybacking technique that may be used is described in “In-band Signaling.” The INQUIRY SCAN request includes different combinations of parameters. For example, one parameter may indicate the type of INQUIRY SCAN, e.g., a general INQUIRY SCAN or a dedicated Connectivity INQUIRY SCAN (i.e., listening only for Connectivity INQUIRIES). Other parameters may indicate the beginning and/or end of the interval within which the INQUIRY SCAN should be performed, the length of the INQUIRY SCAN period, and the repetition period of intervals within which INQUIRY SCANs should be performed.

The INQUIRY SCAN request is confirmed or rejected by the slave. The request could also be treated as an unconfirmed recommendation, which the slave fulfils if it can. Confirmation/rejection from the slave is preferably sent piggybacked on a packet used for other purposes, e.g., a user data packet. Both requests and responses could of course also be carried in Link Manager Protocol (LMP) messages.

The master could also send a request to slave nodes to perform INQUIRIES within a certain time interval or even periodically, using the same or similar parameters as in the INQUIRY SCAN requests, where the length of the INQUIRY SCAN period is translated into a number of INQUIRY messages. A possible qualification of the request is to indicate what the slave should do if a unit responds to the inquiry. One possible instruction is to page the responding unit if a default set of conditions for connection apply, such as the unit has a different scatternet identity or is a certain number of hops away within the same scatternet. The scatternet identity concept is described in U.S. patent application Ser. No. 09/709,643, entitled “Random Identity Management in Scatternets,” Johan Rune, filed on Nov. 13, 2000. Another possible instruction is to report the result to the master, preferably including the entire INQUIRY RESPONSE message.

The INQUIRY requests are preferably piggybacked with other packets, similar to the INQUIRY SCAN requests, but LMP messages are also possible. The requests could be confirmed or unconfirmed.

When deciding how to distribute the INQUIRIES and INQUIRY SCAN periods between the nodes in the piconet, the master considers the current traffic load of each node, a node's topological status (e.g., the number of piconet memberships), the type of device, etc. Generally, since the master node's time and other resources are the most valuable in a piconet, the master may choose to participate in the compound INQUIRY and INQUIRY SCAN efforts of the piconet or leave it entirely to the slave nodes. The scheduling of the INQUIRIES and INQUIRY SCAN periods among the slaves is simplified if an intra-piconet scheduling algorithm like Batched Fair Exhaustive Polling (BFEP) is used. The predetermined batches give the master some knowledge regarding when a node will be polled the next time, or at least that it will not be polled again for a certain number of frames. This known “poll-free” time is suitable for an INQUIRY or an INQUIRY SCAN period. The BFEP algorithm is described in U.S. patent application Ser, No. 09/455,172, entitled “Batched Fair Exhaustive Polling Scheduler,” by Per Johansson and Niklas Johansson, filed Dec. 6, 1999, which is hereby incorporated by reference.

Scheduling PAGE SCANS and informing potential paging units that are connected to the same scatternet of the scheduled PAGE SCAN periods is a known concept. This has been described in “Efficient Scatternet Forming.” The same concept may be extended to potential paging units that are not part of the same scatternet. In addition, the concept could be extended to include PAGE SCAN frequency information and refined in other ways to make it as efficient as possible. With this concept PAGES and PAGE SCANS can be performed, using very little of the time and resources of the involved devices.

When the involved units are not connected to the same scatternet, the added necessary information is included in the INQUIRY RESPONSE message. In the preferred embodiment, this modified INQUIRY RESPONSE message is only returned in response to INQUIRY messages including a special CIAC. This ensures backwards compatibility with devices that do not support the modified INQUIRY RESPONSE message. However, it is also possible to let a device respond with the modified INQUIRY RESPONSE message to an INQUIRY message including the GIAC.

The same scheduled PAGE SCAN period can be announced in several INQUIRY RESPONSE messages to several inquiring devices. However, if a scheduled PAGE SCAN period is not announced to any other device, the scheduled PAGE SCAN period should be cancelled.

The description will now focus on the added INQUIRY RESPONSE message information needed for the PAGE SCAN scheduling scheme, irrespective of what IAC that is used to trigger the message. The description is made with reference to a 79-hop system, but it can easily be modified to suit a 23-hop system.

Timing information must be included in the INQUIRY RESPONSE message in order to achieve efficient PAGE SCAN scheduling. Timing information is most easily expressed as the number of time units until the next planned PAGE SCAN period. A time unit could be a single frame, two frames, or any number of frames. Alternatively, a time unit could be expressed in milliseconds or some other arbitrary time unit, but an integer number of frames is probably the most suitable.

Information identifying a PAGE/PAGE SCAN frequency to be used has to be included. The paging device and the scanning device will normally use different algorithms to arrive at the same frequency, since the scanning device uses a semi-constant PAGE SCAN frequency (changing every 1.28 seconds), while the paging device sweeps across the entire range of possible PAGE frequencies (32 for 79-hop systems and 16 for 23-hop systems), switching frequency every 312.5 ps. The paging device normally sweeps across the PAGE frequencies, because it uses an estimate of the scanning device's clock to estimate what PAGE SCAN frequency the scanning device is using. By including an indication of the exact PAGE SCAN frequency to be used in the INQUIRY RESPONSE message, the paging device can simply use the indicated PAGE frequency and save the time and processing efforts required to sweep across a number of frequencies.

In a 79-hop system, the PAGE/PAGE SCAN frequencies are selected from 32 different possible frequencies that are determined by the 28 lowest bits in the BD_ADDR of the scanning device. While it is possible to indicate the exact frequency to be used, it is more advantages to indicate an input to be used in the frequency selection algorithm. The same indicated input could then be used as input to the subsequent slave response and master response frequency selection algorithms. The PAGE SCAN frequency selection algorithm is simpler and requires less input than the PAGE frequency selection algorithm. Therefore, the input indicated in the INQUIRY RESPONSE message preferably refers to PAGE SCAN frequency selection algorithm with both devices using this algorithm to calculate their respective frequencies, that is, the PAGE and PAGE SCAN frequency.

The third required piece of information in the INQUIRY RESPONSE message is a new value of the Page Scan Mode parameter indicating that the response includes information about a scheduled PAGE SCAN period. Currently, four of the eight possible values of the Page Scan Mode parameter are undefined. One of them could be used to indicate the “Scheduled Page Scan Mode”. An additional possibility would be to define several of the currently undefined values to indicate different variants of “Scheduled Page Scan Modes.”

The above three pieces of information added to the INQUIRY RESPONSE message are sufficient to enable a new Scheduled Page Scan Mode. However, several other pieces of information are also useful for making the PAGE SCAN scheduling more sophisticated.

A scheduled short PAGE SCAN period enables fast and efficient paging, but it also causes contention problems. If several units decide to PAGE a certain scanning unit during the same scheduled PAGE SCAN period, the short duration of the PAGE SCAN period may result in the paging units interfering with each other during the entire PAGE SCAN period. There are several possible solutions to this problem, which are further described below. One solution is to include an announcement counter in the INQUIRY RESPONSE message. This counter would indicate how many times the currently announced PAGE SCAN period has been announced before. That is, the counter would indicate the number of previous INQUIRY RESPONSE messages that the currently announced PAGE SCAN period was included in. If the number of previous announcements exceeds the maximum value of the counter, the counter is set to its maximum value. An inquiring unit can use the information obtained from the announcement counter when choosing whether to PAGE a certain unit. For example, if the value of the announcement counter exceeds a threshold, which could be as low as zero, the inquiring unit may choose to PAGE another unit or wait for a later opportunity to PAGE the responding unit.

The PAGE SCAN scheduling becomes even more flexible as more information is provided. Information of interest could be, e.g., an indication of the length of the PAGE SCAN period (i.e., the length of the period during which the device is in PAGE SCAN mode). The scheduled PAGE SCAN information may also convey the repetition of several PAGE SCAN periods. If so, indications of the repetition interval and the number of planned repetitions would be of interest.

The above information is sufficient for scheduling of a PAGE SCAN period for the device responding to the INQUIRY message. However, when general connectivity is the purpose of the INQUIRY, the inquiring device may also receive scheduling information about the responding device's master. The inquiring device could then choose to connect to the master of the piconet instead of a slave unit responding device. Additionally, a mechanism can be employed to reverse the paging direction and allow the inquiring device to connect to the master as a slave unit, as described in U.S. patent application Ser. No. 09/729,926, entitled “Intelligent Piconet Forming,” Johan Rune et al., filed Dec. 6, 2000 (“Intelligent Piconet Forming”).

PAGE SCAN scheduling information for the master unit in the INQUIRY RESPONSE message must include the 28 lowest bits of the BD_ADDR of the master. The time and frequency information could correspond to the responding device's time and frequency information. The Page Scan Mode parameter could be common for both devices or a separate Page Scan Mode parameter could be included for the master. The INQUIRY RESPONSE message could include some part or all of the non-required information for the master device, except the announcement counter. The announcement counter is excluded, because a device announcing a PAGE SCAN period on behalf of its master will not know how many times other devices, or the master itself, have announced the same PAGE SCAN period.

Including PAGE SCAN scheduling information about the master of the responding device (referred to as the “two-device-case”) is generally preferable. However, in some cases, it is preferable to only include PAGE SCAN information related to the responding device (referred to as the “single-device-case”). For example, when the trade-offs needed to enable the two-device-case are considered too severe, the single-device-case is preferable. One drawback associated with the two-device-case is the increased signaling required to transfer the PAGE SCAN scheduling information of the master to the slaves. Another drawback is that the Class of Device field in the INQUIRY RESPONSE message has to be used for information related to the PAGE SCAN scheduling (discussed further later). Other reasons to use the single-device-case include when the responding device does not have a master, either because it is idle or because it is the master itself, or when the PAGE SCAN scheduling information related to the master is not available. If the single-device-case is used dynamically, depending on the topological status of the responding unit (i.e., master or idle), the INQUIRY RESPONSE message must include an indication of this status. This could be done using two undefined bits in the INQUIRY RESPONSE message, as described in “Intelligent Piconet Forming.” In addition, if the single-device-case is used (dynamically), because the PAGE SCAN scheduling information related to the master is not available to the responding device, or because the master does not use a Scheduled Page Scan Mode, then the corresponding reason must be indicated in the INQUIRY RESPONSE message. Preferably, this is done by including a separate Page Scan Mode field for the master device, with a value indicating that no Scheduled Page Scan Mode information related to the master can be expected in the INQUIRY RESPONSE message (discussed further below).

Accordingly, several different information parameters, and some of the possible variations will be described in more detail.

PAGE SCAN Timing Parameter (PST)

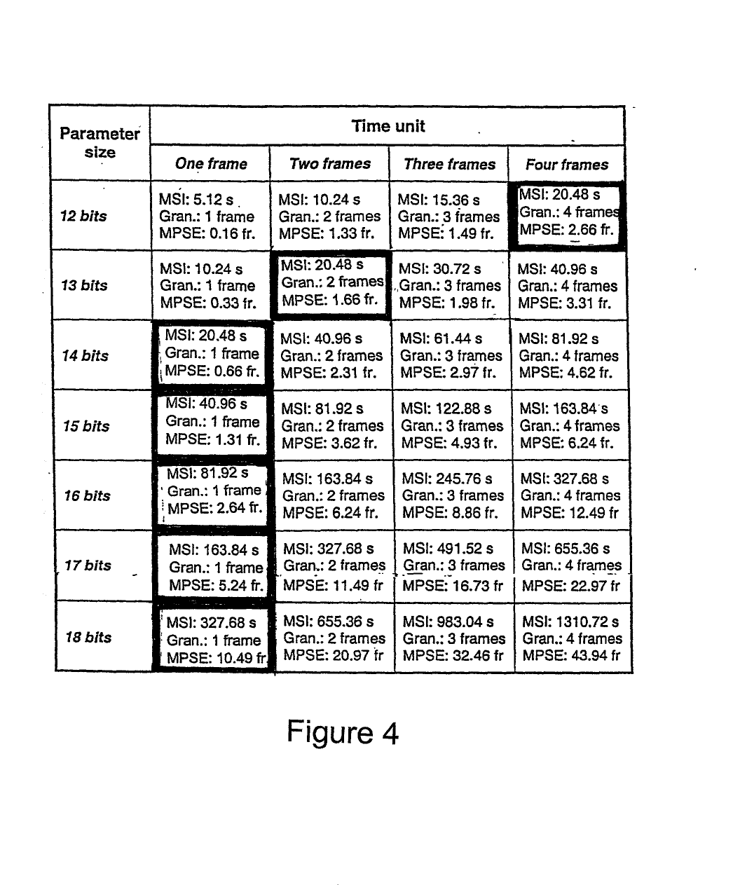

The PST could use a variety of time units, but a time unit is preferably an integer number of frames. A reasonable size of the parameter is 12-15 bits, although it could be longer, especially in the single-device-case. The table shown in FIG. 4 lists the resulting maximum scheduling interval (MSI), scheduling granularity (Gran.) and the maximum PAGE scheduling error (MPSE) for some of the different combinations of parameter size and choices of time unit. The preferred time unit for each parameter size is indicated by the thicker boxes. The MPSE is the maximum timing error that the paging device can incur when trying to match its PAGE to the scheduled PAGE SCAN period. This error is calculated as MPSE (maximum granularity error)+(maximum drift error). The granularity error is the scheduling granularity divided by two and rounded downwards to an integer number of frames. The maximum drift error is the result of double the maximum allowed drift of a Bluetooth clock crystal (i.e., double 20 ppm) exercised during the entire maximum scheduling interval. The generic formula for MPSE measured in frames then becomes:

MPSE=(Int(Gran./2)×1.25×10⁻³+2×2×10⁻⁵×MSI)/1.25×10⁻³=Int(Gran./2)+0.032×MSI (1)

To be sure to cover the entire PAGE SCAN period, a paging device starts to PAGE at Int(Gran./2)+0.032×SI number of frames before the estimated start, where Si stands for the scheduling interval measured in seconds, and ends the PAGE period at the same number of frames after the estimated end of the PAGE SCAN period. So the length of the PAGE period in frames is calculated as PSP+2×(Int(Gran./2)+0.032×IS), where PSP is the length of the PAGE SCAN period measured in the number of frames. In the worst case, when IS=MSI, the expression within parenthesis in the above formula becomes the expression for the maximum PAGE scheduling error. Hence, to find the maximum length (in number of frames) of a PAGE period (MPP), the following simple formula can be used: MPP=PSP+2×MPSE. All of the above is valid for the PST parameter for both the responding device (PST_{R}) and its master (PST_{M}).

Input to PAGE SCAN Frequency Selection Algorithm (FSAI)

Since the frequency to be used during the scheduled PAGE SCAN period is indicated to the potential pager, both the paging and the scanning device can use the same algorithm to derive the frequency that is used during the PAGE and the PAGE SCAN. This algorithm is preferably the one normally used by the scanning device. The input data to this algorithm normally consists of the 28 lowest bits (i.e., bit 0-27) of the BD_ADDR of the scanning device and bit 12-16 (12-15 in 23-hop systems) of the native clock of the scanning device (denoted CLK₁₆₋₁₂ in 79-hop systems and CLK₁₅₋₁₂ in 23-hop systems). The 28 lowest bits of the BD_ADDR are transferred in the INQUIRY RESPONSE message, so they are known by both devices. The value that CLK₁₆₋₁₂ will have when the scheduled PAGE SCAN period is executed could also be transferred in the INQUIRY RESPONSE message. But to avoid the situation when these bits change during the PAGE SCAN period, it is actually better to transfer a fictive input instead of the real CLK₁₆₋₁₂. The input is preferably 4-5 bits long. If 5 bits are used, a full fictive CLK₁₆₋₁₂ value is transferred. If 4 bits are used, they will represent CLK₁₅₋₁₂, while CLK₁₆ is set to zero by default. A result of this one-bit reduction is that the number of possible PAGE/PAGE SCAN frequencies is reduced from 32 to 16, which is still more than enough to avoid fix interference sources. In addition, the reduced number of frequencies is more than compensated for by the fact that the PAGE period is much shorter than in the regular case and that the paging device only has to use a single frequency for every PAGE period, instead of sweeping through a range of frequencies. So, in conclusion, the transferred parameter representing the input to the frequency selection algorithm should be either 5 randomly chosen bits or 4 randomly chosen bits, with the 5th bit implicitly set to zero by default. The above is valid for the FSAI parameter for both the responding device (FSAI_{R}) and its master (FSAI_{M}).

Page Scan Mode Parameter (PSM)

As stated previously, scheduling page scans requires a new value for the Page Scan Mode parameter. One of the four presently undefined values is used for the Scheduled Page Scan Mode. This value also implicitly tells the inquiring unit that parts of the regular INQUIRY RESPONSE message has been redefined to include information related to the PAGE SCAN scheduling and how this information can be interpreted.

The PSM parameter may be common for the responding unit and its master or, if the available bits are sufficient, there could be one parameter each for the responding unit (PSM_{R}) and its master (PSM_{M}). If a common PSM parameter is used, but the master does not use the Scheduled Page Scan Mode (or its PAGE SCAN schedule is unknown to the responding unit), a specific value of one of the other parameters, such as setting the PST_{M} parameter to all ones, could be used to indicate that the scheduling information for the master should be disregarded.

Other values of the Page Scan Mode parameter could be used to indicate variants of the Scheduled Page Scan Mode. For example, variants with longer PAGE SCAN periods or for which a second (or even more) scan period is already implicitly scheduled to occur a fixed (predefined) number of frames after the first one and using a scanning frequency that is calculated after adding a fixed (predefined) offset value to the FSAI parameter. In another variant, the Scheduled Page Scan Mode is used for the responding unit, but no information is included about the responding unit's master, thus providing more room for the required information in the INQUIRY RESPONSE message. Using the Page Scan Mode Parameter to indicate that the included Scheduled Page Scan Mode related information is restricted to the responding device should not be confused with the other previously described reasons to exclude the information related to the Scheduled Page Scan Mode of the master device (i.e., that the responding device is either idle or the master itself, that the master does not use a Scheduled Page Scan Mode, or that the information concerning the master is simply not available).

Other useful definitions of the remaining values of the Page Scan Mode parameter would be “Not Performing PAGE SCAN” and “Page Scan Mode unspecified/unknown.” An example of when the former would be useful is a mouse connected via Bluetooth to its laptop. The mouse could possibly perform inquiry scans on behalf of its master (the laptop) while the master is busy. The mouse indicates its master's page scan schedule in its inquiry responses, but also indicates that the mouse does not perform PAGE SCANS, since it is not interested in being paged. The “Page Scan Mode unspecified/unknown” indication could be used by a unit that does not want to commit to a certain Page Scan Mode, but performs PAGE SCANS occasionally. Specifically, for the PSM_{M} parameter, the “Page Scan Mode unspecified/unknown” value could be used when the PAGE SCAN schedule of the master is not known to the responding unit.

The four remaining values of the Page Scan Parameter are of course not sufficient for all of the above. However, the most useful definitions can be implemented. One way to save a PSM value is to combine “Not Performing PAGE SCAN” and “Page Scan Mode unspecified/unknown” into one value, since they are more or less equivalent for an inquiring unit.

Furthermore, the “mandatory” Page Scan Mode (as specified in Bluetooth Core 1.0b) could be made voluntary or optional, at least for connected units, since it does not make the most efficient use of each BT unit's resources, such as processing time and battery power.

Additional Parameters for the two-device-case

Additional parameters are required to enable the two-device-case. When the two-device-case is used, which is preferable, another set of the above-described required parameters relating to the master is added, with the exception possibly of the Page Scan Mode parameter, if a common Page Scan Mode parameter for the responding unit and its master is used.

BD_ADDR₀₋₂₇ is a required input to the frequency selection algorithms. In addition, the Lower Address Part (LAP), BD_ADDR₀₋₂₄, is used to generate the Device Access Code (DAC) of a device, which is used for paging, for example.

The Upper Address Part (UAP), BD_ADDR₂₄₋₃₁, is used to generate the Header Error Check (HEC) in Baseband packets, including messages exchanged during the PAGE procedure. In the connection state, the BD_ADDR₂₄₋₃₁ of the master is used for all HEC generations within the piconet. But when an FHS packet is used as a page master response, the HEC of the FHS packet is generated from the slave's (the scanning unit's) BD_ADDR₂₄₋₃₁. Therefore, if the BD_ADDR₂₈₋₃₁ of the responding unit's master, or of the responding unit, is not included in the INQUIRY RESPONSE message, four other bits have to be used in combination with the scanning unit's BD_ADDR₂₄₋₂₇ (i.e., the BD_ADDR₂₄₋₂₇ of the responding unit's master), when generating the HEC for the FHS packet in the master page response. The four bits could be set to a default value or they could simply be the four bits that are put in the position of the INQUIRY RESPONSE message where the BD_ADDR₂₈₋₃₁ would have been if it had been present (i.e., next to BD_ADDR₂₇). However, the bits must not change from one announcement of a PAGE SCAN period to the next. This is also applicable for the BD_ADDR₂₈₋₃₁ of the responding unit.

Optional Parameters

Scheduling may be made more sophisticated with the addition of other optional parameters to enable the Scheduled Page Scan. Whether they should be used or not depends on the benefits they add and on how scarce the available bits in the INQUIRY RESPONSE message are. There is less competition for the available bits in the single-device-case than in the two-device-case, making it more attractive to include the optional parameters in the single-device-case. Another consideration is whether a scatternet identity is used or not. If a scatternet identity is included in the INQUIRY RESPONSE message, less room is available for the optional parameters.

Announcement Counter (AC)

The AC, as described above, may optionally be added for the responding device, even in the two-device-case. A suitable size for use in the INQUIRY RESPONSE message is probably 1-3 bits.

PAGE SCAN Period (PSP)

The PSP parameter indicates the length of the scheduled PAGE SCAN period expressed in an arbitrary time unit, e.g., 1 frame. Since this parameter is optional, very few bits are preferably assigned to indicate one of a number of predefined periods including multiple time units, instead of indicating a number of time units.

A suitable parameter size is 2-8 bits for the single-device-case and 1-2 bits for the two-device-case. If the parameter is only 1 bit long, then only two different PAGE SCAN period lengths are indicated, such as 4 and 16 frames. If the parameter is 2 bits long, then four different period lengths are indicated, such as 4, 10, 20 and 40 frames.

The PSP parameter is applicable for both the responding device (PSP_{R}) and its master (PSP_{M}).

Please note that although it serves a similar purpose, the PSP parameter should not be confused with the SP (Scan Period) parameter in the regular INQUIRY RESPONSE message.

PAGE SCAN Repetition Interval (PSRI)

The PSRI parameter could be used when the PAGE SCAN scheduling involves repetitive PAGE SCAN periods. The parameter indicates the interval between the start of two consecutive PAGE SCAN periods within the same PAGE SCAN scheduling. Similar to the PSP parameter, the PSRI parameter is expressed in an arbitrary time unit, e.g.,1 frame, or, preferably, as an indication of one of a number of predefined intervals. If repetitive PAGE SCAN periods are desired, but there is no room for this parameter, a fixed predefined repetition interval can be used instead.

A suitable parameter size is 2-8 bits for the single-device-case and 1-2 bits for the two-device-case.

The PSRI parameter is applicable for both the responding device (PSRI_{R}) and its master (PSRI_{M}).

Please note that although it serves a similar purpose, the PSRI parameter should not be confused with the SR (Scan Repetition) parameter in the regular INQUIRY RESPONSE message.

Number of PAGE SCAN Repetitions (NPSR)

Similar to the PSRI parameter, the NPSR parameter could be used when the PAGE SCAN scheduling involves repetitive PAGE SCAN periods. The parameter indicates the number of times a scheduled PAGE SCAN period will be repeated. The parameter could be a simple binary representation of the relevant number or an indication of one out of a set of predefined numbers.

A suitable parameter size is 2-4 bits for the single-device-case and 1-2 bits for the two-device-case.

The NPSR parameter is applicable for both the responding device (NPSR_{R}) and its master (NPSR_{M}).

Adding the Parameters to the INQUIRY RESPONSE Message

In order to include all the necessary information in the INQUIRY RESPONSE message, some of the current fields of the INQUIRY RESPONSE message (i.e., an FHS packet) must be redefined.

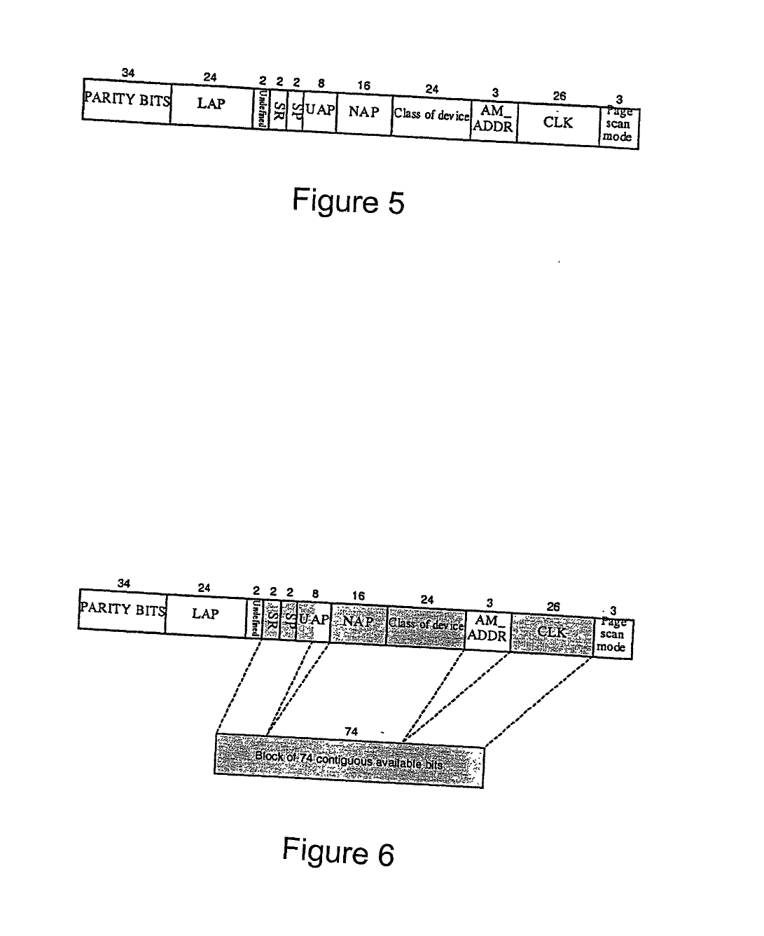

The format of a conventional FHS packet is illustrated in FIG. 5 for reference purposes. The CLK field is used to transfer the current clock value of the responding unit to the inquiring unit. If the inquiring unit decides to PAGE the responding unit, this information is used to estimate the clock value of the unit to be paged. The estimated clock value is then used as an input to the frequency selection algorithm for the paging unit. However, when the Scheduled Page Scan Mode is used, the exact PAGE frequency to use is implicitly indicated, making the CLK field unnecessary. This makes the 26 bits of the CLK field available for other information.

Secondly, when the Scheduled Page Scan Mode is used, the SR (Scan Repetition) and SP (Scan Period) fields are also unnecessary, freeing another 4 bits for other information.

Another field that can be redefined without significant impact is the NAP (Nonsignificant Address Part) field. The NAP field is not used for generation of any code, unlike the LAP field, which is used for generation of the DAC, and the UAP, which is used for generation of the HEC. The NAP field is also not used in the frequency selection algorithms. Hence, the 16 bits of the NAP field is available for other purposes, with the only disadvantage being that after the PAGE procedure the paging unit would not know the complete BD_ADDR of the paged unit. However, to enable mechanisms making use of the complete BD_ADDR in the connection state, the NAP could be transferred as soon as a connection has been established.

The 4 highest bits of the UAP field can also be redefined for other types of information. The 4 lower bits are necessary for the frequency selection algorithm, as described above, but the 4 highest bits are only used for HEC generation. However, the 4 highest bits of the UAP field in the INQUIRY RESPONSE message are used for HEC generation only in the first Master Page Response message. In the connection state, the master's UAP is used for HEC generation by all nodes in the piconet. If these 4 bits could be replaced during this single occasion, as described above, the 4 bits are made available for other information during other periods.

Yet another field that could be redefined is the Class of Device field. When general connectivity is the ultimate goal of the INQUIRY procedure, it is not very important to know the class of the responding device. This frees another 24 bits.

It is also possible to use the 2 bits of the undefined field and/or the 3 bits of the AM_ADDR field. But these fields may be used to carry topology related information, which may be of great interest for an inquiring unit seeking to increase the general connectivity, such as master/slave status and number of slaves in the piconet or number of reachable, but not connected, units. This possible use of the undefined field and the AM_ADDR field is described in “Intelligent Piconet Forming.”

The Page Scan Mode field will also be used to carry information related to the Scheduled Page Scan Mode. It will not be redefined, but it will include a new value, or one of the new values, defined for the Page Scan Mode parameter.

In total, 74 bits are available for the additional parameters, excluding the undefined field, the AM_ADDR field and the Page Scan Mode field. All 74 bits may be used for the above-described information related to the Scheduled Page Scan Mode. Alternatively, some of these bits may be used to represent a scatternet identity.

If the scatternet identity feature is used, the number of bits required depends on what is assessed as an acceptable risk of having two co-located scatternets simultaneously using the same scatternet identity. For example, if 8 bits are used for the scatternet identity, 8 scatternets may be present in the same place with a 90% probability that none of them has the same scatternet identity as another one. A 7-bit scatternet identity would allow only 5 co-located scatternets with 92% probability of all scatternets having unique scatternet identities. A 6-bit scatternet identity allows for 4 co-located scatternets with a 91% uniqueness probability or 6 scatternets with a 79% uniqueness probability.

There are a number of alternative ways to distribute the available bits in the FHS packet among the parameters associated with the Scheduled Page Scan Mode. The properties, trade-offs, pros and cons are briefly described below for several exemplary alternatives. In the following descriptions, the available bits are treated as a block of 74 contiguous bits for simplicity as illustrated in FIG. 6, although in reality the bits are distributed to multiple blocks across the FHS packet.

Several of the possible exemplary alternatives are described below. They are grouped according to the two main cases, the two-device-case and the single-device-case. Within each of these two groups, a number of alternatives including a scatternet identity are described first, followed by alternatives using no scatternet identity. Of course, many more alternatives are possible, but these are chosen for illustration of the concept and how its trade-offs and properties depend on the distribution of the available bits.

The Two-Device-Case With a Scatternet Identity

Alternative 1

| | | |
|---|---|---|
| Page Scan Timing Parameter for Responding Device (PST_{R}) | 13 | bits |
| Page Scan Timing Parameter for Master Device (PST_{M}) | 13 | bits |
| Input to PAGE SCAN Frequency Selection | 4 | bits |
| Algorithm for Responding Device (FSAI_{R}) | | |
| Input to PAGE SCAN Frequency Selection | 4 | bits |
| Algorithm for Master Device (FSAI_{M}) | | |
| Page Scan Mode Parameter for Master Device (PSM_{M}) | 3 | bits |
| BD_ADDR₀₋₂₇ Of Master Device (BDM) | 28 | bits |
| Announcement Counter (AC) | 1 | bit |
| Scatternet Identity (ScID) | 8 | bits |

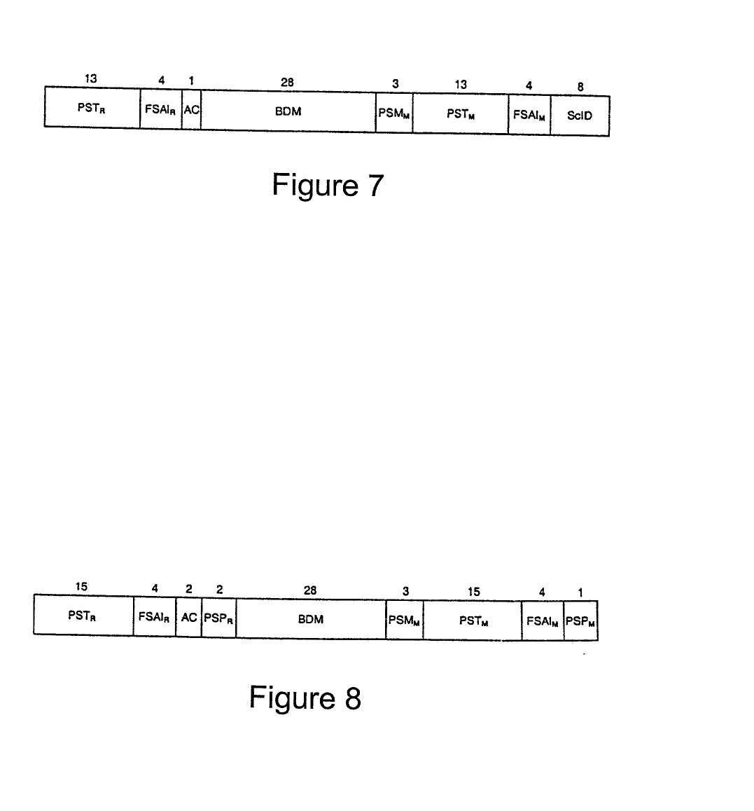

The packet of Alternative 1 is illustrated in FIG. 7. Alternative 1 is the preferred alternative for the two-device-case when a scatternet identity is used. The Page Scan Mode parameter for the responding device (PSM_{R}) is included with the regular Page Scan Mode parameter and is therefore not included in the 74 available bits.

The 13-bit PST parameters provide a reasonably good scheduling interval and scheduling granularity. The trade-off between scheduling interval and scheduling granularity, depending on the choice of time unit, is illustrated with reference to the table of FIG. 4. The preferred time unit for this alternative is 2 frames, providing a maximum scheduling interval of 20.48 seconds and a maximum PAGE scheduling error of 1.66 frames. If a PAGE SCAN period of 4 frames is chosen, the scanning device would use 4 frames for the PAGE SCAN and a paging device would have to use 7.32 frames (8 frames in practice) to be sure to cover the entire PAGE SCAN period.

The single bit announcement counter is sufficient to indicate whether the scheduled PAGE SCAN period has been announced in previous INQUIRY RESPONSE messages, but not to indicate how many times this has happened. However, this simple indication may be sufficient.

The 8-bit scatternet identity provides good uniqueness properties.

Alternative 2

| | | |
|---|---|---|
| Page Scan Timing Parameter for Responding Device (PST_{R}) | 13 | bits |
| Page Scan Timing Parameter for Master Device (PST_{M}) | 13 | bits |
| Input to PAGE SCAN Frequency Selection | 4 | bits |
| Algorithm for Responding Device (FSAI_{R}) | | |
| Input to PAGE SCAN Frequency Selection | 4 | bits |
| Algorithm for Master Device (FSAI_{M}) | | |
| Page Scan Mode Parameter for Master Device (PSM_{M}) | 3 | bits |
| BD_ADDR₀₋₂₇ Of Master Device (BDM) | 28 | bits |
| Announcement Counter (AC) | 1 | bit |
| PAGE SCAN Period for Responding Device (PSP_{R}) | 1 | bit |
| Scatternet Identity (ScID) | 7 | bits |

The Page Scan Mode parameter for the responding device (PSM_{R}) is included with the regular Page Scan Mode parameter and is therefore not included in the 74 available bits.

Alternative 2 is similar to Alternative 1, with the scatternet identity length reduced to 7 bits to allow the addition of a 1-bit PSP_{R} parameter. Hence, the PSP_{R} parameter is used to announce two different PAGE SCAN Period lengths, increasing the flexibility of the Scheduled Page Scan Mode at the expense of the uniqueness properties of the scatternet identity, which are still fairly good.

Alternative 3

| | | |
|---|---|---|
| Page Scan Timing Parameter for Responding Device (PST_{R}) | 13 | bits |
| Page Scan Timing Parameter for Master Device (PST_{M}) | 13 | bits |
| Input to PAGE SCAN Frequency Selection | 4 | bits |
| Algorithm for Responding Device (FSAI_{R}) | | |
| Input to PAGE SCAN Frequency Selection | 4 | bits |
| Algorithm for Master Device (FSAI_{M}) | | |
| Page Scan Mode Parameter for Master Device (PSM_{M}) | 3 | bits |
| BD_ADDR₀₋₂₇ of Master Device (BDM) | 28 | bits |
| PAGE SCAN Period for Responding Device (PSP_{R}) | 2 | bits |
| Scatternet Identity (ScID) | 7 | bits |

The Page Scan Mode parameter for the responding device (PSM_{R}) is included with the regular Page Scan Mode parameter and is therefore not included in the 74 available bits.

Alternative 3 is similar to Alternative 2, with the PSP_{R} parameter increased to 2 bits to add additional lengths of the scheduled PAGE SCAN periods. The announcement counter is removed to give room for the additional bit. The PSP_{R} parameter is used to compensate for the absent announcement counter. If a specific PAGE SCAN period has been announced previously, the responding device can perform step by step increases of the length of the scheduled PAGE SCAN Period to be able to handle pages from more than one device during the same scheduled PAGE SCAN period. To spread the PAGES from different devices to different parts of the scheduled PAGE SCAN period, one possibility is to let the paging devices start at different times in the PAGE SCAN period or use different fractions of the PAGE SCAN period. The starting time or fraction to use could be derived from the BD_ADDR of the paging device.

Alternative 4

| | | |
|---|---|---|
| Page Scan Timing Parameter for Responding Device (PST_{R}) | 13 | bits |
| Page Scan Timing Parameter for Master Device (PST_{M}) | 13 | bits |
| Input to PAGE SCAN Frequency Selection | 4 | bits |
| Algorithm for Responding Device (FSAI_{R}) | | |
| Input to PAGE SCAN Frequency Selection | 4 | bits |
| Algorithm for Master Device (FSAI_{M}) | | |
| Page Scan Mode Parameter for Master Device (PSM_{M}) | 3 | bits |
| BD_ADDR₀₋₂₇ of Master Device (BDM) | 28 | bits |
| Announcement Counter (AC) | 1 | bit |
| PAGE SCAN Period for Responding Device (PSP_{R}) | 1 | bit |
| PAGE SCAN Period for Master Device (PSP_{M}) | 1 | bit |
| Scatternet Identity (ScID) | 6 | bits |

The Page Scan Mode parameter for the responding device (PSM_{R}) is included with the regular Page Scan Mode parameter and is therefore not included in the 74 available bits.

Alternative 4 is similar to Alternative 2, with a 1-bit PSP_{M} parameter added. With two PSP parameters included, some flexibility in the lengths of the PAGE SCAN periods is achieved for both the responding device and its master. The bit for the PSP_{M} parameter was taken from the scatternet identity, which results in poor uniqueness properties.

Alternative 5

| | | |
|---|---|---|
| Page Scan Timing Parameter for Responding Device (PST_{R}) | 13 | bits |
| Page Scan Timing Parameter for Master Device (PST_{M}) | 13 | bits |
| Input to PAGE SCAN Frequency Selection | 4 | bits |
| Algorithm for Responding Device (FSAI_{R}) | | |
| Input to PAGE SCAN Frequency Selection | 4 | bits |
| Algorithm for Master Device (FSAI_{M}) | | |
| Page Scan Mode Parameter for Master Device (PSM_{M}) | 3 | bits |
| BD_ADDR₀₋₂₇ of Master Device (BDM) | 28 | bits |
| Announcement Counter (AC) | 2 | bits |
| Scatternet Identity (ScID) | 7 | bits |

The Page Scan Mode parameter for the responding device (PSM_{R}) is included with the regular Page Scan Mode parameter and is therefore not included in the 74 available bits.

Alternative 5 is similar to Alternative 1, with the announcement counter extended to 2 bits at the expense of the scatternet identity, whose size has been decreased to 7 bits. The announcement counter consequently provides more detailed information, since up to three previous announcements can be indicated, while the uniqueness properties of the scatternet identity remain fairly good.

Alternative 6

| | | |
|---|---|---|
| Page Scan Timing Parameter for Responding Device (PST_{R}) | 12 | bits |
| Page Scan Timing Parameter for Master Device (PST_{M}) | 12 | bits |
| Input to PAGE SCAN Frequency Selection | 5 | bits |
| Algorithm for Responding Device (FSAI_{R}) | | |
| Input to PAGE SCAN Frequency Selection | 5 | bits |
| Algorithm for Master Device (FSAI_{M}) | | |
| Page Scan Mode Parameter for Master Device (PSM_{M}) | 3 | bits |
| BD_ADDR₀₋₂₇ Of Master Device (BDM) | 28 | bits |
| Announcement Counter (AC) | 1 | bit |
| Scatternet Identity (ScID) | 8 | bits |

The Page Scan Mode parameter for the responding device (PSM_{R}) is included with the regular Page Scan Mode parameter and is therefore not included in the 74 available bits.

In this alternative the FSAI parameters are 5 bits each, giving the maximum number of possible PAGE/PAGE SCAN frequencies (but in a 23 hop system one bit in each parameter would be wasted). The 12 bit PST parameters provide poor scheduling properties. With reference to the table of FIG. 4, to achieve an acceptable maximum scheduling interval, the time unit must be 4 frames. This provides a maximum scheduling interval of 20.48 seconds and a maximum PAGE scheduling error of 2.66 frames. If a PAGE SCAN period of 4 frames is chosen, the scanning device requires 4 frames for the PAGE SCAN and a paging device uses 9.32 frames (10 frames in practice) to be sure to cover the entire PAGE SCAN period.

Alternative 7

| | | |
|---|---|---|
| Page Scan Timing Parameter for Responding Device (PST_{R}) | 13 | bits |
| Page Scan Timing Parameter for Master Device (PST_{M}) | 13 | bits |
| Input to PAGE SCAN Frequency Selection | 5 | bits |
| Algorithm for Responding Device (FSAI_{R}) | | |
| Input to PAGE SCAN Frequency Selection | 5 | bits |
| Algorithm for Master Device (FSAI_{M}) | | |
| Page Scan Mode Parameter for Master Device (PSM_{M}) | 3 | bits |
| BD_ADDR₀₋₂₇ of Master Device (BDM) | 28 | bits |
| Announcement Counter (AC) | 1 | bit |
| Scatternet Identity (ScID) | 6 | bits |

The Page Scan Mode parameter for the responding device (PSM_{R}) is included with the regular Page Scan Mode parameter and is therefore not included in the 74 available bits.

Alternative 7 is similar to Alternative 6, with FSAI parameters of 5 bits long, but the FSAI parameters have been extended at the expense of the scatternet identity instead of the PST parameters. Consequently, reasonably good scheduling properties are maintained (with 2 frames as the preferred time unit), while the uniqueness properties of the scatternet identity (only 6 bits) become significantly worse.

Alternative 8

| | | |
|---|---|---|
| Page Scan Timing Parameter for Responding Device (PST_{R}) | 15 | bits |
| Page Scan Timing Parameter for Master Device (PST_{M}) | 15 | bits |
| Input to PAGE SCAN Frequency Selection | 4 | bits |
| Algorithm for Responding Device (FSAI_{R}) | | |
| Input to PAGE SCAN Frequency Selection | 4 | bits |
| Algorithm for Master Device (FSAI_{M}) | | |
| BD_ADDR₀₋₂₇ Of Master Device (BDM) | 28 | bits |
| Scatternet Identity (ScID) | 8 | bits |

Alternative 8 does not have separate Page Scan Mode parameters for the responding device and its master. Instead, a common Page Scan Mode parameter is used for both devices. The common Page Scan Mode parameter is included in the regular Page Scan Mode parameter and therefore does not have to be fit into the 74 available bits. The announcement counter has also been removed.

This alternative has very good scheduling properties because of the 15 bit PST parameters. If a time unit of 1 frame is chosen, the maximum scheduling interval becomes 40.96 seconds and the maximum PAGE scheduling error becomes 1.31 frames. If a PAGE SCAN period of 4 frames is chosen, this means that a scanning device would use 4 frames for the PAGE SCAN and a paging device would have to use 6.62 frames (7 frames in practice) to be sure to cover the entire PAGE SCAN period.

The major trade-off is that there is no separate PSM parameter for the master device. This means that if PAGE SCAN scheduling information for the master is provided, the master must use the same Scheduled Page Scan Mode as the responding device. If the master uses another Page Scan Mode (scheduled or non-scheduled) or does not perform PAGE SCANS at all, this would have to be indicated using a dedicated value of one of the other parameters, e.g., by setting the PST_{M} parameter to all ones.

Another trade-off is that there is no announcement counter.

Alternative 9

| | | |
|---|---|---|
| Page Scan Timing Parameter for Responding Device (PST_{R}) | 15 | bits |
| Page Scan Timing Parameter for Master Device (PST_{M}) | 15 | bits |
| Input to PAGE SCAN Frequency Selection | 4 | bits |
| Algorithm for Responding Device (FSAI_{R}) | | |
| Input to PAGE SCAN Frequency Selection | 4 | bits |
| Algorithm for Master Device (FSAI_{M}) | | |
| BD_ADDR₀₋₂₇ Of Master Device (BDM) | 28 | bits |
| Announcement Counter (AC) | 2 | bits |
| Scatternet Identity (ScID) | 6 | bits |

Alternative 9 does not have separate Page Scan Mode parameters for the responding device and its master. Instead, a common Page Scan Mode parameter is used for both devices. The common Page Scan Mode parameter is included in the regular Page Scan Mode parameter and therefore does not have to be fit into the 74 available bits.

This alternative is similar to Alternative 8, since there is no separate PSM parameter for the master and the scheduling properties are very good. But in Alternative 9 an announcement counter has been introduced at the expense of the scatternet identity. Reducing the size of the scatternet identity from 8 to 6 bits makes its uniqueness properties significantly worse.

Alternative 10

| | | |
|---|---|---|
| Page Scan Timing Parameter for Responding Device (PST_{R}) | 12 | bits |
| Page Scan Timing Parameter for Master Device (PST_{M}) | 12 | bits |
| Input to PAGE SCAN Frequency Selection | 4 | bits |
| Algorithm for Responding Device (FSAI_{R}) | | |
| Input to PAGE SCAN Frequency Selection | 4 | bits |
| Algorithm for Master Device (FSAI_{M}) | | |
| BD_ADDR₀₋₂₇ of Master Device (BDM) | 28 | bits |
| Scatternet Identity (ScID) | 6 | bits |

Alternative 10 does not have separate Page Scan Mode parameters for the responding device and its master. Instead, a common Page Scan Mode parameter is used for both devices. The common Page Scan Mode parameter is included in the regular Page Scan Mode parameter and therefore does not have to be fit into the 74 available bits.

This alternative is similar to Alternative 8, since the included parameters are the same. However, the size of the PST parameters is only 12 bits, resulting in worsened scheduling properties. Another difference is that the scatternet identity has been reduced to 6 bits, making its uniqueness properties significantly worse. But the most important difference is that when you sum up the bits of the parameters, you arrive at only 66 instead of 74. The 8 saved bits can be used to transfer intact UAP fields for both the responding unit and the master. That is, the 4 highest bits of the UAP fields of the responding unit and its master are not claimed by other parameters related to the Scheduled Page Scan Mode in this alternative. This means that the problem associated with the HEC generation in the PAGE procedure (as described above) can be avoided.

Strictly speaking, including the 4 highest bits of the master's UAP really results in adding another 4 bits to the BDM parameter so it contains the BD_ADDR₀₋₃₁ of the master device. This variant of the BDM parameter, denoted BDM₀₋₃₁, and the parameter list becomes.

| | | |
|---|---|---|
| Page Scan Timing Parameter for Responding Device (PST_{R}) | 12 | bits |
| Page Scan Timing Parameter for Master Device (PST_{M}) | 12 | bits |
| Input to PAGE SCAN Frequency Selection | 4 | bits |
| Algorithm for Responding Device (FSAI_{R}) | | |
| Input to PAGE SCAN Frequency Selection | 4 | bits |
| Algorithm for Master Device (FSAI_{M}) | | |
| BD_ADDR₀₋₃₁ of Master Device (BDM₀₋₃₁) | 32 | bits |
| Scatternet Identity (ScID) | 6 | bits |

(The 4 highest bits of the UAP of the responding device (UAP₄_{-7R}) 4 bits)

The Two-Device-Case Without a Scatternet Identity

When the scatternet identity is excluded, a number of additional bits are available for other parameters. These bits can be used, for example, to improve the scheduling properties, to include non-required parameters, or to return the highest bits to the UAP parameters to avoid the HEC generation problem.

Alternative 11

| | | |
|---|---|---|
| Page Scan Timing Parameter for Responding Device (PST_{R}) | 17 | bits |
| Page Scan Timing Parameter for Master Device (PST_{M}) | 17 | bits |
| Input to PAGE SCAN Frequency Selection | 4 | bits |
| Algorithm for Responding Device (FSAI_{R}) | | |
| Input to PAGE SCAN Frequency Selection | 4 | bits |
| Algorithm for Master Device (FSAI_{M}) | | |
| Page Scan Mode Parameter for Master Device (PSM_{M}) | 3 | bits |
| BD_ADDR₀₋₂₇ of Master Device (BDM) | 28 | bits |
| Announcement Counter (AC) | 1 | bit |

The Page Scan Mode parameter for the responding device (PSM_{R}) is included with the regular Page Scan Mode parameter and is therefore not included in the 74 available bits.

The PST parameter is 17 bits long, which provides very good scheduling properties. The preferred time unit is 1 frame, resulting in a maximum scheduling interval of 163.84 seconds with a maximum PAGE scheduling error of 5.24 frames. The only included non-required parameter is a 1-bit announcement counter (in addition to the separate PSM_{M} parameter for the master device).

Alternative 12

| | | |
|---|---|---|
| Page Scan Timing Parameter for Responding Device (PST_{R}) | 16 | bits |
| Page Scan Timing Parameter for Master Device (PST_{M}) | 16 | bits |
| Input to PAGE SCAN Frequency Selection | 4 | bits |
| Algorithm for Responding Device (FSAI_{R}) | | |
| Input to PAGE SCAN Frequency Selection | 4 | bits |
| Algorithm for Master Device (FSAI_{M}) | | |
| Page Scan Mode Parameter for Master Device (PSM_{M}) | 3 | bits |
| BD_ADDR₀₋₂₇ of Master Device (BDM) | 28 | bits |
| Announcement Counter (AC) | 1 | bit |
| PAGE SCAN Period for Responding Device (PSP_{R}) | 1 | bit |
| PAGE SCAN Period for Master Device (PSP_{M}) | 1 | bit |

The Page Scan Mode parameter for the responding device (PSM_{R}) is included with the regular Page Scan Mode parameter and is therefore not included in the 74 available bits.

In Alternative 12, the PST parameters are reduced by one bit each as compared to Alternative 11. But the 16-bit PST parameters still provide very good scheduling properties. The preferred time unit is 1 frame in this alternative. This gives a maximum scheduling interval of 81.92 seconds with a maximum PAGE scheduling error of 2.64 frames. The two bits that were taken from the PST parameters are used to accommodate a PSP_{R} and a PSP_{M} parameter of 1 bit each, making it possible to choose between two different lengths of the PAGE SCAN Periods for both the responding device and its master.

Alternative 13

| | | |
|---|---|---|
| Page Scan Timing Parameter for Responding Device (PST_{R}) | 15 | bits |
| Page Scan Timing Parameter for Master Device (PST_{M}) | 15 | bits |
| Input to PAGE SCAN Frequency Selection | 4 | bits |
| Algorithm for Responding Device (FSAI_{R}) | | |
| Input to PAGE SCAN Frequency Selection | 4 | bits |
| Algorithm for Master Device (FSAI_{M}) | | |
| Page Scan Mode Parameter for Master Device (PSM_{M}) | 3 | bits |
| BD_ADDR₀₋₂₇ Of Master Device (BDM) | 28 | bits |
| Announcement Counter (AC) | 2 | bits |
| PAGE SCAN Period for Responding Device (PSP_{R}) | 2 | bits |
| PAGE SCAN Period for Master Device (PSP_{M}) | 1 | bit |

The Page Scan Mode parameter for the responding device (PSM_{R}) is included with the regular Page Scan Mode parameter and is therefore not included in the 74 available bits.

Alternative 13 is similar to Alternative 12, with the size of the PST parameters reduced even further to 15 bits each, which still provides very good scheduling properties. The two additional bits are used to extend the announcement counter and the PSP_{R} parameter to 2 bits each.

Alternative 13 is the preferred alternative for the two-device-case when no scatternet identity is used. The packet of Alternative 13 is illustrated in FIG. 8.

Alternative 14

| | | |
|---|---|---|
| Page Scan Timing Parameter for Responding Device (PST_{R}) | 15 | bits |
| Page Scan Timing Parameter for Master Device (PST_{M}) | 15 | bits |
| Input to PAGE SCAN Frequency Selection | 4 | bits |
| Algorithm for Responding Device (FSAI_{R}) | | |
| Input to PAGE SCAN Frequency Selection | 4 | bits |
| Algorithm for Master Device (FSAI_{M}) | | |
| Page Scan Mode Parameter for Master Device (PSM_{M}) | 3 | bits |
| BD_ADDR₀₋₂₇ Of Master Device (BDM) | 28 | bits |
| Announcement Counter (AC) | 1 | bit |
| PAGE SCAN Period for Responding Device (PSP_{R}) | 1 | bit |
| PAGE SCAN Period for Master Device (PSP_{M}) | 1 | bit |
| Number of PAGE SCAN Repetitions for Responding Dev. | 1 | bit |
| (NPSR_{R}) | | |
| Number of PAGE SCAN Repetitions for Master Device | 1 | bit |
| (NPSR_{M}) | | |

The Page Scan Mode parameter for the responding device (PSM_{R}) is included with the regular Page Scan Mode parameter and is therefore not included in the 74 available bits.

Alternative 14 is similar to Alternative 13 in that the PST parameters are 15 bits long. However, the two bits that were used to extend the PSP parameters in Alternative 13 are instead used for a NPSR_{R} and a NPSR_{M} parameter of 1 bit each in Alternative 14 to accommodate a repetition of the PAGE SCAN periods. The NPSR parameters make it possible to choose between two different numbers of repetition. Since there are no PSRI parameters, the repetition intervals are assumed to be predefined, either as a fixed interval or as a dynamic interval which is defined in relation to the length of the PAGE SCAN period. For example, the repetition interval may be predefined to 10 times the length of the PAGE SCAN period.

Alternative 15

| | | |
|---|---|---|
| Page Scan Timing Parameter for Responding Device (PST_{R}) | 14 | bits |
| Page Scan Timing Parameter for Master Device (PST_{M}) | 14 | bits |
| Input to PAGE SCAN Frequency Selection | 4 | bits |
| Algorithm for Responding Device (FSAI_{R}) | | |
| Input to PAGE SCAN Frequency Selection | 4 | bits |
| Algorithm for Master Device (FSAI_{M}) | | |
| Page Scan Mode Parameter for Master Device (PSM_{M}) | 3 | bits |
| BD_ADDR₀₋₂₇ Of Master Device (BDM) | 28 | bits |
| Announcement Counter (AC) | 1 | bit |
| PAGE SCAN Period for Responding Device (PSP_{R}) | 1 | bit |
| PAGE SCAN Period for Master Device (PSP_{M}) | 1 | bit |
| PAGE SCAN Repetition Interval for Responding Device | 1 | bit |
| (PSRI_{R}) | | |
| PAGE SCAN Repetition Interval for Master Device (PSRI_{M}) | 1 | bit |
| Number of PAGE SCAN Repetitions for Responding Dev. | 1 | bit |
| (NPSR_{R}) | | |
| Number of PAGE SCAN Repetitions for Master Device | 1 | bit |
| (NPSR_{M}) | | |

The Page Scan Mode parameter for the responding device (PSM_{R}) is included with the regular Page Scan Mode parameter and is therefore not included in the 74 available bits.

In Alternative 15, the PST parameters are reduced to 14 bits each, which provides rather good scheduling properties. The preferred time unit is 1 frame, providing a maximum scheduling interval of 20.48 seconds and a maximum PAGE scheduling error of 0.66 frames. The two additional bits that are made available, as compared to Alternative 14, are used to include a 1-bit PSRI_{R} parameter and a 1-bit PSRI_{M} parameter. Consequently, it is possible to choose between two different repetition intervals, for both the responding device and its master. In this alternative, all the non-required parameters are included, making the Scheduled Page Scan Mode very flexible.

Alternative 16

| | | |
|---|---|---|
| Page Scan Timing Parameter for Responding Device (PST_{R}) | 13 | bits |
| Page Scan Timing Parameter for Master Device (PST_{M}) | 13 | bits |
| Input to PAGE SCAN Frequency Selection | 4 | bits |
| Algorithm for Responding Device (FSAI_{R}) | | |
| Input to PAGE SCAN Frequency Selection | 4 | bits |
| Algorithm for Master Device (FSAI_{M}) | | |
| Page Scan Mode Parameter for Master Device (PSM_{M}) | 3 | bits |
| BD_ADDR₀₋₂₇ Of Master Device (BDM) | 28 | bits |
| Announcement Counter (AC) | 1 | bit |
| PAGE SCAN Period for Responding Device (PSP_{R}) | 2 | bits |
| PAGE SCAN Period for Master Device (PSP_{M}) | 2 | bits |
| PAGE SCAN Repetition Interval for Responding Device | 1 | bit |
| (PSRI_{R}) | | |
| PAGE SCAN Repetition Interval for Master Device (PSRI_{M}) | 1 | bit |
| Number of PAGE SCAN Repetitions for Responding Dev. | 1 | bit |
| (NPSRR) | | |
| Number of PAGE SCAN Repetitions for Master Device | 1 | bit |
| (NPSR_{M}) | | |

The Page Scan Mode parameter for the responding device (PSM_{R}) is included with the regular Page Scan Mode parameter and is therefore not included in the 74 available bits.

Alternative 16 is similar to Alternative 15, with the PST parameters further reduced to13 bits. The parameters benefitting from this are non-required parameters, and more particularly, the PSP parameters, which are extended to 2 bits each. The presence of all non-required parameters, and the extension of the PSP parameters, results in a very flexible Scheduled Page Scan Mode. As compared with Alternative 15, the flexibility in the length of the PAGE SCAN period is increased at the expense of the scheduling properties.

Alternative 17

| | | |
|---|---|---|
| Page Scan Timing Parameter for Responding Device (PST_{R}) | 13 | bits |
| Page Scan Timing Parameter for Master Device (PST_{M}) | 13 | bits |
| Input to PAGE SCAN Frequency Selection | 4 | bits |
| Algorithm for Responding Device (FSAI_{R}) | | |
| Input to PAGE SCAN Frequency Selection | 4 | bits |
| Algorithm for Master Device (FSAI_{M}) | | |
| Page Scan Mode Parameter for Master Device (PSM_{M}) | 3 | bits |
| BD_ADDR₀₋₂₇ of Master Device (BDM) | 28 | bits |
| Announcement Counter (AC) | 3 | bits |
| PAGE SCAN Period for Responding Device (PSP_{R}) | 1 | bit |
| PAGE SCAN Period for Master Device (PSP_{M}) | 1 | bit |
| PAGE SCAN Repetition Interval for Responding Device | 1 | bit |
| (PSRI_{R}) | | |
| PAGE SCAN Repetition Interval for Master Device (PSRI_{M}) | 1 | bit |
| Number of PAGE SCAN Repetitions for Responding Dev. | 1 | bit |
| (NPSR_{R}) | | |
| Number of PAGE SCAN Repetitions for Master Device | 1 | bit |
| (NPSR_{M}) | | |

The Page Scan Mode parameter for the responding device (PSM_{R}) is included with the regular Page Scan Mode parameter and is therefore not included in the 74 available bits.

Alternative 17 is similar to Alternative 16, with 13-bit PST parameters and all the non-required parameters. But instead of using 2 bits to extend the PSP parameters to 2 bits each, the two extra available bits have been used to extend the announcement counter to 3 bits. The 3 bits make it possible for the announcement counter to provide detailed information, which helps resolve the contention problem. If the PAGE SCAN period is long enough, it could be divided into several parts, numbered e.g., from 0 to 7 to match the range of the 3-bit announcement counter. An inquiring device is implicitly allocated the part of the scheduled PAGE SCAN period with the same number as the value of the announcement counter. Thus, if several devices plan to PAGE the scanning device during the same scheduled PAGE SCAN period, they will not interfere with each other (to be really sure they would have to use guard times to account for the PAGE scheduling error).

Alternative 18

| | | |
|---|---|---|
| Page Scan Timing Parameter for Responding Device (PST_{R}) | 13 | bits |
| Page Scan Timing Parameter for Master Device (PST_{M}) | 13 | bits |
| Input to PAGE SCAN Frequency Selection | 5 | bits |
| Algorithm for Responding Device (FSAI_{R}) | | |
| Input to PAGE SCAN Frequency Selection | 5 | bits |
| Algorithm for Master Device (FSAI_{M}) | | |
| Page Scan Mode Parameter for Master Device (PSM_{M}) | 3 | bits |
| BD_ADDR₀₋₂₇ Of Master Device (BDM) | 28 | bits |
| Announcement Counter (AC) | 1 | bit |
| PAGE SCAN Period for Responding Device (PSP_{R}) | 1 | bit |
| PAGE SCAN Period for Master Device (PSP_{M}) | 1 | bit |
| PAGE SCAN Repetition Interval for Responding Device | 1 | bit |
| (PSRI_{R}) | | |
| PAGE SCAN Repetition Interval for Master Device (PSRI_{M}) | 1 | bit |
| Number of PAGE SCAN Repetitions for Responding Dev. | 1 | bit |
| (NPSR_{R}) | | |
| Number of PAGE SCAN Repetitions for Master Device | 1 | bit |
| (NPSR_{M}) | | |

The Page Scan Mode parameter for the responding device (PSM_{R}) is included with the regular Page Scan Mode parameter and is therefore not included in the 74 available bits.

Similar to Alternatives 16 and 17, the PST parameters are 13 bits each and all non-required parameters are included. But in this alternative none of the non-required parameters are extended—they are all as short as possible, i.e., 1 bit each, except the PSM_{M} parameter, which is 3 bits long.

Instead, the FSAI parameters are extended to 5 bits each, giving the maximum number of 32 possible PAGE/PAGE SCAN frequencies. However, having 32 possible frequencies, while advantageous in a 79 hop system, would not be useful in a 23-hop system for obvious reasons.

Alternative 19

| | | |
|---|---|---|
| Page Scan Timing Parameter for Responding Device (PST_{R}) | 13 | bits |
| Page Scan Timing Parameter for Master Device (PST_{M}) | 13 | bits |
| Input to PAGE SCAN Frequency Selection | 4 | bits |
| Algorithm for Responding Device (FSAI_{R}) | | |
| Input to PAGE SCAN Frequency Selection | 4 | bits |
| Algorithm for Master Device (FSAI_{M}) | | |
| Page Scan Mode Parameter for Master Device (PSM_{M}) | 3 | bits |
| BD_ADDR₀₋₃₁ of Master Device (BDM₀₋₃₁) | 32 | bits |
| Announcement Counter (AC) | 1 | bit |

(The 4 highest bits of the UAP of the responding device (UAP₄_{-7R}) 4 bits)

The Page Scan Mode parameter for the responding device (PSM_{R}) is included with the regular Page Scan Mode parameter and is therefore not included in the 74 available bits.

Alternative 19 is based on Alternative 1. The PST parameters are 13 bits long and the only non-required parameters are the PSM_{M} parameter and a 1 bit announcement counter. The 8 bits of the scatternet identity have instead been used to make the UAP parameters of both the responding device and its master complete, thereby avoiding the problem with the HEC generation during the PAGE procedure, as described above. In the case of the master, the BDM parameter is extended to a BDM₀₋₃₁ parameter.

The Single-Device-Case

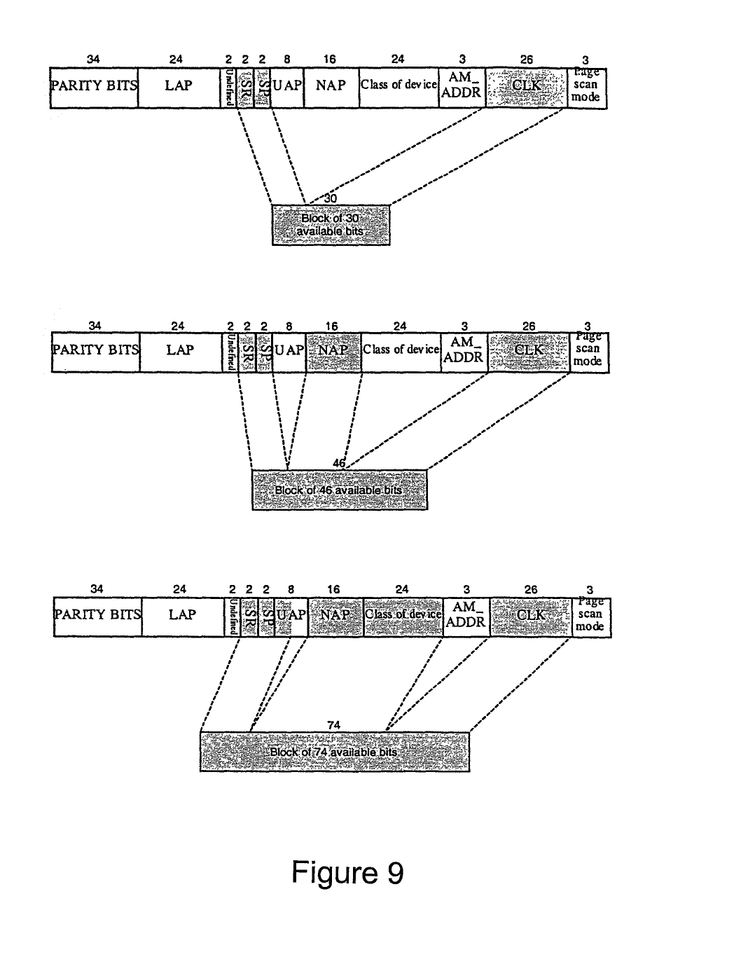

When the information related to the Scheduled Page Scan Mode only concerns one device, i.e., the responding device, 74 bits is more than needed. Some of these bits can be “returned” to their original purpose. The first fields to return are the Class of Device field and the 4 highest bits of the UAP field. The number of available bits is then reduced to 46. However, this may still be considered more than is needed. The next field to return is the NAP field, bringing the number of available bits to 30. In this section the three exemplary cases will be considered, i.e., having 30, 46 or 74 bits available for the information related to the Scheduled Page Scan Mode, as illustrated in FIG. 9. As can be appreciated, several other combinations are possible, e.g., to return only the 4 highest bits of the UAP field, resulting in 70 available bits.

Additionally, the single-device-case can be used in either of two basic scenarios, with associated sub-cases. First, the single-device-case can be used when the two-device-case is considered unwanted for some reason. This is henceforth referred to as the “only-single-device-case scenario.” Second, the single-device-case can be used dynamically as a complement to the two-device-case, in certain situations when the two-device-case is not applicable. This is henceforth referred to as the “dynamic-single-device-case-scenario”.

Within the dynamic-single-device-case-scenario, there are four basic sub-cases:

1) When the topological status of the responding device governs the use of the single-device-case, the use of the single-device-case can be implicitly indicated by the topological status information in the INQUIRY RESPONSE message, e.g., using the two undefined bits. This is applicable when the responding device is either idle or a master. This is henceforth referred to as the “topological-status-case” of the dynamic-single-device-case-scenario.

2) When the Page Scan Mode of the master or the availability of information related to the Page Scan Mode of the master governs the use of the single-device-case. In this scenario, the use of the single-device case can be indicated by the value of the Page Scan Mode field for the master. This would be applicable when the master does not use a Scheduled Page Scan Mode or when the PAGE SCAN scheduling information related to the master is for some reason not known to the responding device. This is henceforth referred to as the “master-page-scan-mode-case” of the dynamic-single-device-case-scenario. Another way is to make it a special use of the two-device-case with the information fields carrying the parameters related to the Scheduled Page Scan Mode of the master device unused.

3) The Page Scan Mode parameter of the responding device indicates that only information related to the Scheduled Page Scan Mode of the responding device is provided in the INQUIRY RESPONSE message. This is an option chosen by the responding device and it could be used regardless of topological status and of whether the information related to the Scheduled Page Scan Mode of the master device is available or not. However, when looking at the parameters to be included in the INQUIRY RESPONSE message and the possible distribution of the available bits among these parameters, this sub-case is equivalent to the topological-status-case. Hence, the bit distribution alternatives that apply to the topological-status-case apply to this sub-case also. This sub-case will henceforth be referred to as the “responding-page-scan-mode-case” of the dynamic-single-device-case-scenario.

4) The INQUIRY RESPONSE message includes information regarding the Scheduled Page Scan Mode for the master of the responding device only. A typical situation is a mouse performing INQUIRY SCANS on behalf of its master, a computer. Another situation is when the responding device has no PAGE SCAN period scheduled within the maximum scheduling interval. Since the mouse is not interested in being paged, or can not be paged within the maximum scheduling interval, there is no need to include any PAGE SCAN information related to the responding device (the mouse) itself. However, including information about the Scheduled Page Scan Mode of the master unit (the computer) may be very useful. But please note that the Page Scan Mode parameter of the responding device must still be included to indicate that the responding device does not perform PAGE SCANS (or that no PAGE SCAN is planned within the maximum scheduling interval) and that the included Scheduled Page Scan related information concerns the master of the responding device. This is referred to as the “only-master-information-case” of the dynamic-single-device-case-scenario. Reinstating the Class of Device field and the NAP field may be quite pointless in this case, since the inquiring device would not be interested in detailed information about the responding device when a subsequent PAGE of the responding device is not possible. Furthermore, a special use of the two-device-case may be employed instead, with the information fields carrying the parameters related to the Scheduled Page Scan Mode of the responding device unused.

When all 74 bits are made available, it may be of interest to include the BD_ADDR of the master unit in the single-device-case. The BD_ADDR of the master unit is not included for the purpose of conveying Scheduled Page Scan Mode related information, but for topology information purposes. The scatternet identities indicate whether two responding nodes are attached to the same scatternet. But, in some cases, this is not sufficient for the inquiring unit, which may want to know whether two nodes are connected to the same piconet. When the focus is on a single piconet, the BD_ADDR of the master provides this more detailed topology information. Of course, if the scatternet identity feature is not used at all, then the argument for including the BD_ADDR of the master in the INQUIRY RESPONSE message of the single-device-case becomes much stronger.

In the alternatives described below, more bits are used for information related to the Scheduled Page Scan Mode of the responding unit than in the two-device-case. An alternative to the dynamic-single-device-case-scenario is to keep the format of the two-device-case and set the insignificant parameters to all zeros. For example, in the topological-status-case the topological information, i.e., the master/slave/idle indication, would indicate that none of the parameters normally related to the master of the responding device is applicable. In the responding-page-scan-mode-case, this would be indicated by the PSM_{R} parameter. In the master-page-scan-mode-case, the PSM_{M} parameter would indicate that the parameters related to the Scheduled Page Scan Mode of the master device are not applicable, but the BDM parameter and the PSM_{M} parameter itself are still applicable. In the only-master-information-case, the PSM_{R} parameter would indicate that none of the parameters normally related to the Scheduled Page Scan Mode of the responding device is applicable (except the PSM_{R} parameter). In order to save one of the quite limited number of still available PSM values, it is possible to let the PSM_{R} parameter have the normal “Scheduled Page Scan Mode” value in this case. Then a dedicated value of one of the parameters related to the Scheduled Page Scan Mode of the responding device (e.g., setting the PST_{R} parameter to all zeros or all ones) could indicate that these parameters are not applicable. This method of using the format of the two-device-case is actually the preferred way to handle the master-page-scan-mode-case and the only-master-information case of the dynamic-single-device-case-scenario.

In all the bit distribution alternatives of the single-device-case, just as in the two-device-case, the Page Scan Mode parameter for the responding device (PSM_{R}) is put in the regular Page Scan Mode parameter and therefore does not have to be fit into the available bits.

Single-Device-Case Alternatives Including a Scatternet Identity

Alternative 20 (30 available bits)

| | | |
|---|---|---|
| Page Scan Timing Parameter for Responding Device (PST_{R}) | 16 | bits |
| Input to PAGE SCAN Frequency Selection | 4 | bits |
| Algorithm for Responding Device (FSAI_{R}) | | |
| Announcement Counter (AC) | 2 | bits |
| Scatternet Identity (ScID) | 8 | bits |

Alternative 20 does not include any non-required parameters, except a 2-bit announcement counter. A repetition feature may still be supported by using default parameter values. Furthermore, the lack of excessive non-required parameters may make it easier to match this alternative with one of the alternatives of the two-device-case, when used in the topological-status-case or the responding-page-scan-mode-case of the dynamic-single-device-case-scenario. Although it is quite possible to let the responding device introduce more flexibility in the Scheduled Page Scan Mode in the dynamic-single-device-case-scenario, it is easier to use the same principles in two corresponding alternatives of the two-device-case and the single-device-case.

The 16-bit PST_{R} parameter provides excellent scheduling properties (this is the optimum size of this parameter). The 8-bit scatternet identity provides good uniqueness properties, which is required for alternatives that are candidates for the only-single-device-case-scenario.

The lack of a separate PSM_{M} parameter makes this alternative impossible to use in the master-page-scan-mode-case of the dynamic-single-device-case-scenario. Additionally, since all the Scheduled Page Scan Mode related parameters concern the responding device, this alternative can not be used for the only-master-information-case of the dynamic-single-device-case-scenario.

Alternative 21 (30 available bits)

| | | |
|---|---|---|
| Page Scan Timing Parameter for Responding Device (PST_{R}) | 15 | bits |
| Input to PAGE SCAN Frequency Selection | 5 | bits |
| Algorithm for Responding Device (FSAI_{R}) | | |
| Announcement Counter (AC) | 2 | bits |
| Scatternet Identity (ScID) | 8 | bits |

In this alternative, the PST_{R} parameter has been reduced by one bit as compared to Alternative 20, still retaining very good scheduling properties. The FSAI_{R} parameter has been increased by one bit, providing the maximum number of possible PAGE/PAGE SCAN frequencies in a 79-hop system (in a 23 hop system 4 bits are sufficient).

The lack of a separate PSM_{M} parameter makes this alternative impossible to use in the master-page-scan-mode-case of the dynamic-single-device-case scenario. Additionally, since all the Scheduled Page Scan Mode related parameters concern the responding device, this alternative can not be used for the only-master-information-case of the dynamic-single-device-case scenario.

Alternative 22 (30 available bits)

| | | |
|---|---|---|
| Page Scan Timing Parameter for Responding Device (PST_{R}) | 15 | bits |
| Input to PAGE SCAN Frequency Selection | 4 | bits |
| Algorithm for Responding Device (FSAI_{R}) | | |
| Announcement Counter (AC) | 2 | bits |
| PAGE SCAN Period for Responding Device (PSP_{R}) | 1 | bit |
| Scatternet Identity (ScID) | 8 | bit |

Alternative 22 is similar to Alternative 20, with a 1-bit PSP_{R} parameter introduced to provide some flexibility to the Scheduled Page Scan Mode. This bit has been taken from the PST_{R} parameter. However, the resulting 15-bit PST_{R} parameter still provides very good scheduling properties.

The lack of a separate PSM_{M} parameter makes this alternative impossible to use in the master-page-scan-mode-case of the dynamic-single-device-case scenario. Additionally, since all the Scheduled Page Scan Mode related parameters concern the responding device, this alternative can not be used for the only-master-information-case of the dynamic-single-device-case scenario.

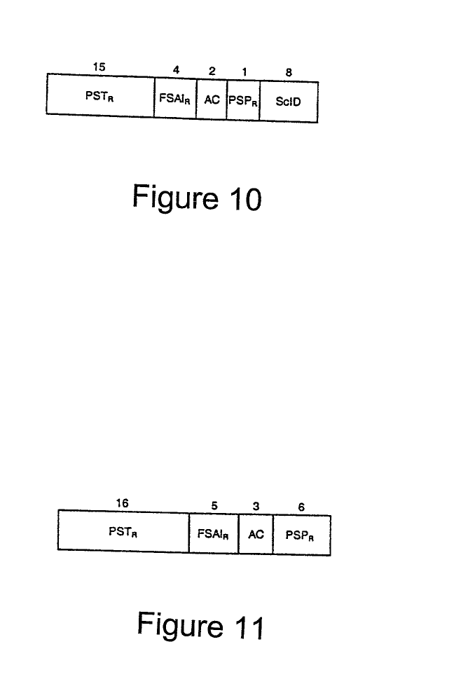

This is the preferred alternative for the only-single-device-case-scenario and the topological-status-case and the responding-page-scan-mode-case of the dynamic-single-device-case-scenario when a scatternet identity is used. The packet of Alternative 22 is illustrated in FIG. 10.

Alternative 23 (30 available bits)

| | | |
|---|---|---|
| Page Scan Timing Parameter for Responding Device (PST_{R}) | 14 | bits |
| Input to PAGE SCAN Frequency Selection | 4 | bits |
| Algorithm for Responding Device (FSAI_{R}) | | |
| Announcement Counter (AC) | 1 | bit |
| PAGE SCAN Period for Responding Device (PSP_{R}) | 1 | bit |
| PAGE SCAN Repetition Interval for Responding Device | 1 | bit |
| (PSRI_{R}) | | |
| Number of PAGE SCAN Repetitions for Responding Dev. | 1 | bit |
| (NPSR_{R}) | | |
| Scatternet Identity (ScID) | 8 | bits |

In Alternative 23, all the non-required parameters are included. Although these parameters have the minimum length of 1 bit each, this still provides flexibility to the Scheduled Page Scan Mode. The 14-bit PST_{R} parameter provides good scheduling properties.

The lack of a separate PSM_{M} parameter makes this alternative impossible to use in the master-page-scan-mode-case of the dynamic-single-device-case scenario. Additionally, since all the Scheduled Page Scan Mode related parameters concern the responding device, this alternative can not be used for the only-master-information-case of the dynamic-single-device-case scenario.

Alternative 24 (30 available bits)

| | | |
|---|---|---|
| Page Scan Timing Parameter for Responding Device (PST_{R}) | 15 | bits |
| Input to PAGE SCAN Frequency Selection | 4 | bits |
| Algorithm for Responding Device (FSAI_{R}) | | |
| Announcement Counter (AC) | 1 | bit |
| PAGE SCAN Period for Responding Device (PSP_{R}) | 1 | bit |
| PAGE SCAN Repetition Interval for Responding Device | 1 | bit |
| (PSRI_{R}) | | |
| Number of PAGE SCAN Repetitions for Responding Dev. | 1 | bit |
| (NPSR_{R}) | | |
| Scatternet Identity (ScID) | 7 | bits |

In Alternative 24, the PST_{R} parameter has been increased by 1 bit at the expense of the scatternet identity as compared to Alternative 23. The resulting 7-bit scatternet identity makes this alternative less attractive for the only-single-device-case-scenario, since in the only-single-device-case-scenario an 8-bit scatternet identity is preferable.

The lack of a separate PSM_{M} parameter makes this alternative impossible to use in the master-page-scan-mode-case of the dynamic-single-device-case scenario. Additionally, since all the Scheduled Page Scan Mode related parameters concern the responding device, this alternative can not be used for the only-master-information-case of the dynamic-single-device-case scenario.

Alternative 25 (30 available bits)

| | | |
|---|---|---|
| Page Scan Timing Parameter for Responding Device (PST_{R}) | 15 | bits |
| Input to PAGE SCAN Frequency Selection | 4 | bits |
| Algorithm for Responding Device (FSAI_{R}) | | |
| Announcement Counter (AC) | 2 | bits |
| PAGE SCAN Period for Responding Device (PSP_{R}) | 2 | bits |
| Scatternet Identity (ScID) | 7 | bits |

Alternative 23 is similar to Alternative 24, but the parameters related to PAGE SCAN repetitions are removed. As a result, it is easier to couple this alternative with an alternative of the two-device-case when used in the topological-status-case or the responding-page-scan-mode-case of the dynamic-single-device-case-scenario. The presence and size of the Scheduled Page Scan Mode related parameters may vary between corresponding alternatives of the two device-case and the single-device-case (although it may be preferable to let them be the same), but the size of the scatternet identity must be invariably the same. Hence, if used in the topological-status-case or the responding page-scan-mode-case of the dynamic-single-device-case-scenario, this alternative should be matched with an alternative of the two-device-case including a 7-bit scatternet identity.

The 7-bit scatternet identity makes this alternative less attractive for the only-single-device-case-scenario, since in the only-single-device-case-scenario an 8-bit scatternet identity is preferable.

The lack of a separate PSM_{M} parameter makes this alternative impossible to use in the master-page-scan-mode-case of the dynamic-single-device-case scenario. Additionally, since all the Scheduled Page Scan Mode related parameters concern the responding device, this alternative can not be used for the only-master-information-case of the dynamic-single-device-case scenario.

Alternative 26 (30 available bits)

| | | |
|---|---|---|
| Page Scan Timing Parameter for Responding Device (PST_{R}) | 15 | bits |
| Input to PAGE SCAN Frequency Selection | 4 | bits |
| Algorithm for Responding Device (FSAI_{R}) | | |
| Announcement Counter (AC) | 1 | bit |
| PAGE SCAN Period for Responding Device (PSP_{R}) | 2 | bit |
| PAGE SCAN Repetition Interval for Responding Device | 1 | bit |
| (PSRI_{R}) | | |
| Number of PAGE SCAN Repetitions for Responding Dev. | 1 | bit |
| (NPSR_{R}) | | |
| Scatternet Identity (ScID) | 6 | bits |

Alternative 26 has a 15-bit PST_{R} parameter, giving very good scheduling properties. And the presence of all the non-required parameters provides flexibility to the Scheduled Page Scan Mode. However, the 6-bit scatternet identity provides poor uniqueness properties and makes this alternative less attractive for the only-single-device-case-scenario, since in the only-single-device-case-scenario an 8-bit scatternet identity is preferable. On the other hand, when used in the topological-status case or the responding-page-scan-mode-case of the dynamic-single-device case-scenario, the 6-bit scatternet identity makes it possible to match this alternative with two-device-case alternatives having a 6-bit scatternet identity.

The lack of a separate PSM_{M} parameter makes this alternative impossible to use in the master-page-scan-mode-case of the dynamic-single-device-case scenario. Additionally, since all the Scheduled Page Scan Mode related parameters concern the responding device, this alternative can not be used for the only-master-information-case of the dynamic-single-device-case scenario.

Alternative 27 (30 available bits)

| | | |
|---|---|---|
| Page Scan Timing Parameter for Responding Device (PST_{R}) | 15 | bits |
| Input to PAGE SCAN Frequency Selection | 4 | bits |
| Algorithm for Responding Device (FSAI_{R}) | | |
| Page Scan Mode Parameter for Master Device (PSM_{M}) | 3 | bits |
| Announcement Counter (AC) | 1 | bit |
| Scatternet Identity (ScID) | 7 | bits |

Alternative 27 is only applicable to the master-page-scan-mode-case of the dynamic-single-device-case-scenario. The enabling parameter for this case is the separate PSM_{M} parameter. On the other hand, the PSM_{M} parameter disqualifies this alternative from the only-single-device-case-scenario.

Since all the Scheduled Page Scan Mode related parameters (except the PSM_{M} parameter) concern the responding device, this alternative can not be used for the only-master-information-case of the dynamic-single-device-case scenario.

Alternative 28 (46 available bits)

| | | |
|---|---|---|
| Page Scan Timing Parameter for Responding Device (PST_{R}) | 18 | bits |
| Input to PAGE SCAN Frequency Selection | 5 | bits |
| Algorithm for Responding Device (FSAI_{R}) | | |
| Announcement Counter (AC) | 3 | bits |
| PAGE SCAN Period for Responding Device (PSP_{R}) | 4 | bits |
| PAGE SCAN Repetition Interval for Responding Device | 4 | bits |
| (PSRI_{R}) | | |
| Number of PAGE SCAN Repetitions for Responding Dev. | 4 | bits |
| (NPSR_{R}) | | |
| Scatternet Identity (ScID) | 8 | bits |

Alternative 28 includes an 18-bit PST_{R} parameter, a 5-bit FSAI_{R} parameter and all the non-required parameters. The 18-bit PST_{R} parameter gives excellent scheduling properties. Even with a time unit of 1 frame, the maximum scheduling interval is 327.68 seconds with a maximum PAGE scheduling error of 10.49 frames. A PST_{R} parameter of as much as 18 bits is more than adequate. The 5-bit FSAI_{R} parameter gives the maximum number of possible PAGE/PAGE SCAN frequencies in a 79-hop system (in a 23 hop system 4 bits are sufficient). The presence of the non-required parameters makes the Scheduled Page Scan Mode very flexible.

The lack of a separate PSM_{M} parameter makes this alternative impossible to use in the master-page-scan-mode-case of the dynamic-single-device-case scenario. Additionally, since all the Scheduled Page Scan Mode related parameters concern the responding device, this alternative can not be used for the only-master-information-case of the dynamic-single-device-case scenario.

Alternative 29 (46 available bits)

| | | |
|---|---|---|
| Page Scan Timing Parameter for Responding Device (PST_{R}) | 16 | bits |
| Input to PAGE SCAN Frequency Selection | 5 | bits |
| Algorithm for Responding Device (FSAI_{R}) | | |
| Announcement Counter (AC) | 3 | bits |
| PAGE SCAN Period for Responding Device (PSP_{R}) | 5 | bits |
| PAGE SCAN Repetition Interval for Responding Device | 5 | bits |
| (PSRI_{R}) | | |
| Number of PAGE SCAN Repetitions for Responding Dev. | 4 | bits |
| (NPSR_{R}) | | |
| Scatternet Identity (ScID) | 8 | bits |

The difference between Alternatives 29 and 28 is that in Alternative 29 the PST_{R} parameter has been decreased to 16 bits and instead the PSP_{R} parameter and the PSRI_{R} parameter have been increased by one bit each. The 16-bit PST_{R} parameter still provides excellent scheduling properties, making it a better choice than an 18-bit PST_{R} parameter.

The lack of a separate PSM_{M} parameter makes this alternative impossible to use in the master-page-scan-mode-case of the dynamic-single-device-case scenario. Additionally, since all the Scheduled Page Scan Mode related parameters concern the responding device, this alternative can not be used for the only-master-information-case of the dynamic-single-device-case scenario.

Alternative 30 (46 available bits)

| | | |
|---|---|---|
| Page Scan Timing Parameter for Responding Device (PST_{R}) | 16 | bits |
| Input to PAGE SCAN Frequency Selection | 5 | bits |
| Algorithm for Responding Device (FSAI_{R}) | | |
| Announcement Counter (AC) | 3 | bits |
| PAGE SCAN Period for Responding Device (PSP_{R}) | 5 | bits |
| PAGE SCAN Repetition Interval for Responding Device | 5 | bits |
| (PSRI_{R}) | | |
| Number of PAGE SCAN Repetitions for Responding Dev. | 4 | bits |
| (NPSR_{R}) | | |
| Scatternet Identity (ScID) | 7 | bits |
| Spare | 1 | bit |

The only difference between Alternatives 30 and 29 is that in Alternative 30 the scatternet identity has been reduced to 7 bits, resulting in the availability of 1 spare bit for future features. The 7-bit scatternet identity makes this alternative less attractive for the only-single-device-case-scenario, since in the only-single-device-case-scenario an 8-bit scatternet identity is preferable. On the other hand, when used in the topology-status case of the dynamic-single-device-case-scenario, the 7-bit scatternet identity makes it possible to match this alternative with two-device-case alternatives including 7-bit scatternet identities.

The lack of a separate PSM_{M} parameter makes this alternative impossible to use in the master-page-scan-mode-case of the dynamic-single-device-case scenario. Additionally, since all the Scheduled Page Scan Mode related parameters concern the responding device, this alternative can not be used for the only-master-information-case of the dynamic-single-device-case scenario.

Alternative 31 (46 available bits)

| | | |
|---|---|---|
| Page Scan Timing Parameter for Responding Device (PST_{R}) | 16 | bits |
| Input to PAGE SCAN Frequency Selection | 4 | bits |
| Algorithm for Responding Device (FSAI_{R}) | | |
| Page Scan Mode Parameter for Master Device (PSM_{M}) | 3 | bits |
| Announcement Counter (AC) | 3 | bits |
| PAGE SCAN Period for Responding Device (PSP_{R}) | 4 | bits |
| PAGE SCAN Repetition Interval for Responding Device | 4 | bits |
| (PSRI_{R}) | | |
| Number of PAGE SCAN Repetitions for Responding Dev. | 4 | bits |
| (NPSR_{R}) | | |
| Scatternet Identity (ScID) | 8 | bits |

The presence of the PSM_{M} parameter (but no other parameters related to the master device) makes this alternative applicable only to the master-page-scan-mode-case of the dynamic-single-device-case-scenario. Furthermore, the 16-bit PST_{R} parameter and the presence of all the non-required parameters provide excellent scheduling properties and a very flexible Scheduled Page Scan Mode.

The lack of a separate PSM_{M} parameter makes this alternative impossible to use in the master-page-scan-mode-case of the dynamic-single-device-case scenario. Additionally, since all the Scheduled Page Scan Mode related parameters concern the responding device, this alternative can not be used for the only-master-information-case of the dynamic-single-device-case scenario.

Alternative 32 (74 available bits)

| | | |
|---|---|---|
| Page Scan Timing Parameter for Responding Device (PST_{R}) | 18 | bits |
| Input to PAGE SCAN Frequency Selection | 5 | bits |
| Algorithm for Responding Device (FSAI_{R}) | | |
| Announcement Counter (AC) | 3 | bits |
| PAGE SCAN Period for Responding Device (PSP_{R}) | 8 | bits |
| Scatternet Identity (ScID) | 7 | bits |
| Spare | 33 | bits |

Alternative 32 results in thirty-three unused (spare) bits that may be reserved for possible future features. Despite the high number of spare bits, the PST_{R} parameter has the excessive length of 18 bits. However, no PAGE SCAN repetition related parameters are included. This is a good alternative if repetition is not considered a useful feature of the Scheduled Page Scan Mode, or if it is considered useful but default parameter values suffice. The presence of the same parameters as in the two-device-case makes it easier to couple Alternative 32 with a two-device-case alternative.

The lack of a separate PSM_{M} parameter makes this alternative impossible to use in the master-page-scan-mode-case of the dynamic-single-device-case scenario. Additionally, since all the Scheduled Page Scan Mode related parameters concern the responding device, this alternative can not be used for the only-master-information-case of the dynamic-single-device-case scenario.

Alternative 33 (74 available bits)

| | | |
|---|---|---|
| Page Scan Timing Parameter for Responding Device (PST_{R}) | 18 | bits |
| Input to PAGE SCAN Frequency Selection | 5 | bits |
| Algorithm for Responding Device (FSAI_{R}) | | |
| Announcement Counter (AC) | 3 | bits |
| PAGE SCAN Period for Responding Device (PSP_{R}) | 8 | bits |
| PAGE SCAN Repetition Interval for Responding Device | 8 | bits |
| (PSRI_{R}) | | |
| Number of PAGE SCAN Repetitions for Responding Dev. | 4 | bits |
| (NPSR_{R}) | | |
| Scatternet Identity (ScID) | 8 | bits |
| Spare | 20 | bits |

Alternative 33 incorporates the maximum (reasonable) size of all required and non-required parameters, with twenty spare bits remaining for use in future features.

The lack of a separate PSM_{M} parameter makes this alternative impossible to use in the master-page-scan-mode-case of the dynamic-single-device-case scenario. Additionally, since all the Scheduled Page Scan Mode related parameters concern the responding device, this alternative can not be used for the only-master-information-case of the dynamic-single-device-case scenario.

Alternative 34 (74 available bits)

| | | |
|---|---|---|
| Page Scan Timing Parameter for Responding Device (PST_{R}) | 16 | bits |
| Input to PAGE SCAN Frequency Selection | 4 | bits |
| Algorithm for Responding Device (FSAI_{R}) | | |
| Announcement Counter (AC) | 3 | bits |
| PAGE SCAN Period for Responding Device (PSP_{R}) | 5 | bits |
| PAGE SCAN Repetition Interval for Responding Device | 4 | bits |
| (PSRI_{R}) | | |
| Number of PAGE SCAN Repetitions for Responding Dev. | 2 | bits |
| (NPSR_{R}) | | |
| Scatternet Identity (ScID) | 8 | bits |
| BD_ADDR₀₋₃₁ of Master Device (BDM₀₋₃₁) | 32 | bits |

Alternative 34 includes all the non-required parameters. In addition, it includes the BDM₀₋₃₁ parameter to provide detailed topological information to the inquiring device, which makes this alternative applicable only to the only-single-device-case-scenario. In the dynamic-single-device-case-scenario, the BDM₀₋₃₁ parameter is useless without any parameters related to the Scheduled Page Scan Mode of the master, with a possible exception for the responding-page-scan-mode-case. In the topological-status-case of the dynamic-single-device case-scenario the responding device would be either idle or the master itself. Hence, the responding device would have no master. In the master-page-scan-mode-case of the dynamic-single-device-case the PSM_{M} parameter must be included and in the only-master-information-case all the parameters related to the Scheduled Page Scan Mode of the master must be included.

Alternative 35 (74 available bits)

| | | |
|---|---|---|
| Page Scan Timing Parameter for Responding Device (PST_{R}) | 16 | bits |
| Input to PAGE SCAN Frequency Selection | 4 | bits |
| Algorithm for Responding Device (FSAI_{R}) | 3 | bits |
| Announcement Counter (AC) | | |
| PAGE SCAN Period for Responding Device (PSP_{R}) | 3 | bits |
| PAGE SCAN Repetition Interval for Responding Device | 3 | bits |
| (PSRI_{R}) | | |
| Number of PAGE SCAN Repetitions for Responding Dev. | 1 | bit |
| (NPSR_{R}) | | |
| Scatternet Identity (ScID) | 8 | bits |
| BD_ADDR₀₋₃₁ of Master Device (BDM₀₋₃₁) | 32 | bits |

(The 4 highest bits of the UAP of the responding device (UAP₄_{-7R}) 4 bits)

Alternative 35 is similar to Alternative 34, with the four highest bits of the UAP of the responding device (UAP_{4-7R}) included at the expense of the PST_{R}, PSRI_{R}, and NPSR_{R} parameters. This makes it possible to avoid the HEC generation problem during the PAGE procedure.

Alternative 36 (74 available bits)

| | | |
|---|---|---|
| Page Scan Timing Parameter for Responding Device (PST_{R}) | 18 | bits |
| Input to PAGE SCAN Frequency Selection | 4 | bits |
| Algorithm for Responding Device (FSAI_{R}) | | |
| Page Scan Mode Parameter for Master Device (PSM_{M}) | 3 | bits |
| Announcement Counter (AC) | 3 | bits |
| PAGE SCAN Period for Responding Device (PSP_{R}) | 8 | bits |
| PAGE SCAN Repetition Interval for Responding Device | 8 | bits |
| (PSRI_{R}) | | |
| Number of PAGE SCAN Repetitions for Responding Dev. | 4 | bits |
| (NPSR_{R}) | | |
| Scatternet Identity (ScID) | 8 | bits |
| Spare | 18 | bits |

Alternative 36 has the maximum (reasonable) size of all required and non-required parameters. In addition, a separate PSM_{M} parameter is included, but no other parameters related to the Scheduled Page Scan Mode of the master device are. Alternative 36 is therefore applicable only to the master-page-scan-mode-case of the dynamic-single-device-case-scenario.

Alternative 37 (74 available bits)

| | | |
|---|---|---|
| Page Scan Timing Parameter for Responding Device (PST_{R}) | 16 | bits |
| Input to PAGE SCAN Frequency Selection | 4 | bits |
| Algorithm for Responding Device (FSAI_{R}) | | |
| Page Scan Mode Parameter for Master Device (PSM_{M}) | 3 | bits |
| Announcement Counter (AC) | 2 | bits |
| PAGE SCAN Period for Responding Device (PSP_{R}) | 4 | bits |
| PAGE SCAN Repetition Interval for Responding Device | 4 | bits |
| (PSRI_{R}) | | |
| Number of PAGE SCAN Repetitions for Responding Dev. | 1 | bit |
| (NPSR_{R}) | | |
| Scatternet Identity (ScID) | 8 | bits |
| BD_ADDR₀₋₃₁ of Master Device (BDM₀₋₃₁) | 32 | bits |

Similar to Alternative 36, Alternative 37 is applicable only to the master-page-scan-mode-case of the dynamic-single-device-case-scenario. But in Alternative 37, the BDM₀₋₃₁ parameter is also included, giving the inquiring device additional topological information.

Alternative 38 (74 available bits)

| | | |
|---|---|---|
| Page Scan Timing Parameter for Master Device (PST_{M}) | 13 | bits |
| Input to PAGE SCAN Frequency Selection | 4 | bits |
| Algorithm for Master Device (FSAI_{M}) | | |
| Page Scan Mode Parameter for Master Device (PSM_{M}) | 3 | bits |
| BD_ADDR₀₋₂₇ Of Master Device (BDM) | 28 | bits |
| PAGE SCAN Period for Master Device (PSP_{M}) | 1 | bit |
| Scatternet Identity (ScID) | 6 | bits |
| Spare | 19 | bits |

Alternative 38 includes parameters related to the Scheduled Page Scan Mode of the master device, but none related to the responding device with the exception of the PSM_{R} parameter, which is placed in the regular PSM parameter. Therefore, this alternative is applicable only to the only-master-information case of the dynamic-single-device-case-scenario.

The parameters related to the Scheduled Page Scan Mode of the master device are not allowed to vary, neither in presence, nor in size, between matching alternatives of the two-device-case and the only-master-information-case of the dynamic-single-device-case-scenario. The reason is that several different slave units could announce the same scheduled PAGE SCAN period of their common master. These announcements may very well be a mix of announcements using the two-device-case and announcements using the only-master-information-case of the dynamic-single-device-case-scenario. In order for the announcements to provide the same information, the parameters should be the same in all cases.

It is apparent that an alternative designed for the only-master-information-case of the dynamic-single-device-case-scenario has strict requirements on the format of the two-device-case alternative that it is coupled with. Alternative 38 has been designed to match Alternative 14 of the two-device-case.

Single-Device-Case Alternatives without a Scatternet Identity

Alternative 39 (30 available bits)

| | | |
|---|---|---|
| Page Scan Timing Parameter for Responding Device (PST_{R}) | 18 | bits |
| Input to PAGE SCAN Frequency Selection | 5 | bits |
| Algorithm for Responding Device (FSAI_{R}) | | |
| Announcement Counter (AC) | 3 | bits |
| Spare | 4 | bits |

Alternative 39 does not include any non-required parameters, except an announcement counter, but leaves 4 bits for future use (spare). The lack of these non-required parameters makes it easier to match Alternative 39 with a two-device-case alternative when it is considered undesirable to have different parameters present when matching the alternatives. Additionally, the complexity of the non-required parameters may not outweigh the benefits of the flexibility they provide in both the dynamic-single-device-case-scenario and the only-single-device-case-scenario.

The few parameters that are included all have the maximum (reasonable) size.

The lack of a separate PSM_{M} parameter makes this alternative impossible to use in the master-page-scan-mode-case of the dynamic-single-device-case scenario. Additionally, since all the Scheduled Page Scan Mode related parameters concern the responding device, this alternative can not be used for the only-master-information-case of the dynamic-single-device-case scenario.

Alternative 40 (30 available bits)

| | | |
|---|---|---|
| Page Scan Timing Parameter for Responding Device (PST_{R}) | 16 | bits |
| Input to PAGE SCAN Frequency Selection | 5 | bits |
| Algorithm for Responding Device (FSAI_{R}) | | |
| Announcement Counter (AC) | 3 | bits |
| PAGE SCAN Period for Responding Device (PSP_{R}) | 6 | bits |

As compared to Alternative 39, a PSP_{R} parameter of 6 bits is added to Alternative 40 at the expense of the spare bits and the PST_{R} parameter. The PSP_{R} parameter provides some flexibility to the Scheduled Page Scan Mode.

The lack of a separate PSM_{M} parameter makes Alternative 40 impossible to use in the master-page-scan-mode-case of the dynamic-single-device-case-scenario. Additionally, since all the Scheduled Page Scan Mode related parameters concern the responding device, this alternative can not be used for the only-master-information-case of the dynamic-single-device-case scenario.

Alternative 40 is the preferred alternative for the only-single-device-case-scenario and the topological-status-case and the responding-page-scan-mode-case of the dynamic-single-device-case-scenario when no scatternet identity is used. A packet according to Alternative 40 is illustrated in FIG. 11.

Alternative 41 (30 available bits)

| | | |
|---|---|---|
| Page Scan Timing Parameter for Responding Device (PST_{R}) | 15 | bits |
| Input to PAGE SCAN Frequency Selection | 4 | bits |
| Algorithm for Responding Device (FSAI_{R}) | | |
| Announcement Counter (AC) | 1 | bit |
| PAGE SCAN Period for Responding Device (PSP_{R}) | 4 | bits |
| PAGE SCAN Repetition Interval for Responding Device | 4 | bits |
| (PSRI_{R}) | | |
| Number of PAGE SCAN Repetitions for Responding Dev. | 2 | bits |
| (NPSR_{R}) | | |

In Alternative 41, all the non-required parameters are included, resulting in a very flexible Scheduled Page Scan Mode. The 15-bit PST_{R} parameter, although smaller than in Alternatives 39 and 40, still provides very good scheduling properties.

The lack of a separate PSM_{M} parameter makes this alternative impossible to use in the master-page-scan-mode-case of the dynamic-single-device-case scenario. Additionally, since all the Scheduled Page Scan Mode related parameters concern the responding device, this alternative can not be used for the only-master-information-case of the dynamic-single-device-case scenario.

Alternative 42 (30 available bits)

| | | |
|---|---|---|
| Page Scan Timing Parameter for Responding Device (PST_{R}) | 15 | bits |
| Input to PAGE SCAN Frequency Selection | 4 | bits |
| Algorithm for Responding Device (FSAI_{R}) | | |
| Announcement Counter (AC) | 2 | bits |
| PAGE SCAN Period for Responding Device (PSP_{R}) | 2 | bits |
| PAGE SCAN Repetition Interval for Responding Device | 2 | bits |
| (PSRI_{R}) | | |
| Number of PAGE SCAN Repetitions for Responding Dev. | 2 | bits |
| (NPSR_{R}) | | |
| Spare | 3 | bits |

In Alternative 42, three spare bits are reserved for future use by reducing the sizes of the non-required parameters, all of which are still included.

The lack of a separate PSM_{M} parameter makes this alternative impossible to use in the master-page-scan-mode-case of the dynamic-single-device-case scenario. Additionally, since all the Scheduled Page Scan Mode related parameters concern the responding device, this alternative can not be used for the only-master-information-case of the dynamic-single-device-case scenario.

Alternative 43 (30 available bits)

| | | |
|---|---|---|
| Page Scan Timing Parameter for Responding Device (PST_{R}) | 17 | bits |
| Input to PAGE SCAN Frequency Selection | 4 | bits |
| Algorithm for Responding Device (FSAI_{R}) | | |
| Page Scan Mode Parameter for Master Device (PSM_{M}) | 3 | bits |
| Announcement Counter (AC) | 3 | bits |
| Spare | 3 | bits |

Alternative 43 is applicable only to the master-page-scan-mode-case of the dynamic-single-device-case-scenario, due to the presence of the PSM_{M} parameter and the absence of all other parameters related to the Scheduled Page Scan Mode of the master device. No parameters related to PAGE SCAN repetitions are included.

Alternative 44 (46 available bits)

| | | |
|---|---|---|
| Page Scan Timing Parameter for Responding Device (PST_{R}) | 18 | bits |
| Input to PAGE SCAN Frequency Selection | 5 | bits |
| Algorithm for Responding Device (FSAI_{R}) | | |
| Announcement Counter (AC) | 3 | bits |
| PAGE SCAN Period for Responding Device (PSP_{R}) | 8 | bits |
| Spare | 12 | bits |

Alternative 44 includes no parameters related to PAGE SCAN repetitions, but all the other parameters related to the Scheduled Page Scan Mode of the responding device are included with maximum (reasonable) sizes. There are 12 spare bits available for possible future features.

The lack of a separate PSM_{M} parameter makes this alternative impossible to use in the master-page-scan-mode-case of the dynamic-single-device-case scenario. Additionally, since all the Scheduled Page Scan Mode related parameters concern the responding device, this alternative can not be used for the only-master-information-case of the dynamic-single-device-case scenario.

Alternative 45 (46 available bits)

| | | |
|---|---|---|
| Page Scan Timing Parameter for Responding Device (PST_{R}) | 16 | bits |
| Input to PAGE SCAN Frequency Selection | 5 | bits |
| Algorithm for Responding Device (FSAI_{R}) | | |
| Announcement Counter (AC) | 3 | bits |
| PAGE SCAN Period for Responding Device (PSP_{R}) | 8 | bits |
| PAGE SCAN Repetition Interval for Responding Device | 8 | bits |
| (PSRI_{R}) | | |
| Number of PAGE SCAN Repetitions for Responding Dev. | 4 | bits |
| (NPSR_{R}) | | |
| Spare | 2 | bits |

In Alternative 45, all non-required parameters are included. All parameters, except the PST_{R} parameter, have their maximum (reasonable) sizes. The PST_{R} parameter is the preferable size of 16 bits instead of maximum 18 bits. The two extra bits are reserved for future use.

The lack of a separate PSM_{M} parameter makes this alternative impossible to use in the master-page-scan-mode-case of the dynamic-single-device-case scenario. And obviously, since all the Scheduled Page Scan Mode related parameters concern the responding device, this alternative can not be used for the only-master-information-case of the dynamic-single-device-case scenario.

Alternative 46 (46 available bits)

| | | |
|---|---|---|
| Page Scan Timing Parameter for Responding Device (PST_{R}) | 13 | bits |
| Input to PAGE SCAN Frequency Selection | 4 | bits |
| Algorithm for Responding Device (FSAI_{R}) | | |
| Announcement Counter (AC) | 1 | bit |
| BD_ADDR₀₋₂₇ of Master Device (BDM) | 28 | bits |

In Alternative 46 all the non-required parameters, except the announcement counter, have been sacrificed to give room for the BDM parameter. The PST_{R} parameter size is also reduced to 13 bits. The presence of the BDM parameter makes this alternative applicable only to the only-single-device-case-scenario. In the dynamic-single-device-case-scenario, with the possible exception of the responding-page-scan-mode-case, the presence of the BDM parameter is useless without any parameters related to the Scheduled Page Scan Mode of the master. In the topological-status-case of the dynamic-single-device-case-scenario, the responding device would be either idle or the master itself. Hence, the responding device would have no master. In the master-page-scan-mode-case of the dynamic-single-device-case the PSM_{M} parameter must be included and in the only-master-information-case all the parameters related to the Scheduled Page Scan Mode of the master must be included.

Alternative 47 (46 available bits)

| | | |
|---|---|---|
| Page Scan Timing Parameter for Responding Device (PST_{R}) | 16 | bits |
| Input to PAGE SCAN Frequency Selection | 5 | bits |
| Algorithm for Responding Device (FSAI_{R}) | | |
| Page Scan Mode Parameter for Master Device (PSM_{M}) | 3 | bits |
| Announcement Counter (AC) | 3 | bits |
| PAGE SCAN Period for Responding Device (PSP_{R}) | 6 | bits |
| PAGE SCAN Repetition Interval for Responding Device | 6 | bits |
| (PSRI_{R}) | | |
| Number of PAGE SCAN Repetitions for Responding Dev. | 4 | bits |
| (NPSR_{R}) | | |
| Spare | 3 | bits |

Alternative 47 includes a separate PSM_{M} parameter, but no other parameters related to the Scheduled Page Scan Mode of the master device, making it applicable only to the master-page-scan-mode-case of the dynamic single-device-case-scenario. For the responding device, all the non-required parameters are present and all the parameters have their maximum or almost maximum (reasonable) sizes. This provides excellent scheduling properties and a very flexible Scheduled Page Scan Mode, while reserving 3 spare bits for future use.

Alternative 48 (74 available bits)

| | | |
|---|---|---|
| Page Scan Timing Parameter for Responding Device (PST_{R}) | 18 | bits |
| Input to PAGE SCAN Frequency Selection | 5 | bits |
| Algorithm for Responding Device (FSAI_{R}) | | |
| Announcement Counter (AC) | 3 | bits |
| PAGE SCAN Period for Responding Device (PSP_{R}) | 8 | bits |
| Spare | 40 | bits |

In Alternative 48, no parameters related to PAGE SCAN repetitions are included, leaving 40 bits unused (spare). The PAGE SCAN repetition parameters may be omitted to make it easier to match this alternative with a two-device-case alternative or because default parameter values are used instead. The parameters that are included all have their maximum (reasonable) sizes.

The lack of a separate PSM_{M} parameter makes this alternative impossible to use in the master-page-scan-mode-case of the dynamic-single-device-case scenario. Additionally, since all the Scheduled Page Scan Mode related parameters concern the responding device, this alternative can not be used for the only-master-information-case of the dynamic-single-device-case scenario.

Alternative 49 (74 available bits)

| | | |
|---|---|---|
| Page Scan Timing Parameter for Responding Device (PST_{R}) | 16 | bits |
| Input to PAGE SCAN Frequency Selection | 5 | bits |
| Algorithm for Responding Device (FSAI_{R}) | | |
| Announcement Counter (AC) | 3 | bits |
| PAGE SCAN Period for Responding Device (PSP_{R}) | 6 | bits |
| PAGE SCAN Repetition Interval for Responding Device | 6 | bits |
| (PSRI_{R}) | | |
| Number of PAGE SCAN Repetitions for Responding Dev. | 2 | bits |
| (NPSR_{R}) | | |
| BD_ADDR₀₋₃₁ of Master Device (BDM₀₋₃₁) | 32 | bits |

(The 4 highest bits of the UAP of the responding device (UAP₄_{-7R}) 4 bits)

In Alternative 49, all the non-required parameters are included. In addition, the BDM₀₋₃₁ parameter and the 4 highest bits of the UAP of the responding device (UAP_{4-7R}) are included. The BDM₀₋₃₁ parameter is included to provide topological information to the inquiring device. This is particularly useful when the scatternet identity is not used. Including the 4 highest bits of the UAP of the responding device makes it possible to avoid the HEC generation problem during the PAGE procedure.

The presence of the BDM₀₋₃₁ parameter makes this alternative applicable only to the only-single-device-case-scenario, since in the dynamic-single-device-case-scenario, with the possible exception of the responding-page-scan-mode-case, the presence of the BDM₀₋₃₁ parameter without any parameters related to the Scheduled Page Scan Mode of the master is useless.

Alternative 50 (74 available bits)

| | | |
|---|---|---|
| Page Scan Timing Parameter for Responding Device (PST_{R}) | 18 | bits |
| Input to PAGE SCAN Frequency Selection | | |
| Algorithm for Responding Device (FSAI_{R}) | 5 | bits |
| Page Scan Mode Parameter for Master Device (PSM_{M}) | 3 | bits |
| Announcement Counter (AC) | 3 | bits |
| PAGE SCAN Period for Responding Device (PSP_{R}) | 8 | bits |
| PAGE SCAN Repetition Interval for Responding Device | 8 | bits |
| (PSRI_{R}) | | |
| Number of PAGE SCAN Repetitions for Responding Dev. | 4 | bits |
| (NPSR_{R}) | | |
| Spare | 25 | bits |

Alternative 50 is applicable only to the master-page-scan-case of the dynamic-single-device-case-scenario, due to the presence of a separate PSM_{M} parameter and no other parameters related to the Scheduled Page Scan Mode of the master device.

For the responding device, all the non-required parameters are included and all parameters have their maximum (reasonable) sizes, with 25 spare bits still reserved for future use.

Alternative 51 (74 available bits)

| | | |
|---|---|---|
| Page Scan Timing Parameter for Responding Device (PST_{R}) | 16 | bits |
| Input to PAGE SCAN Frequency Selection | | |
| Algorithm for Responding Device (FSAI_{R}) | 4 | bits |
| Page Scan Mode Parameter for Master Device (PSM_{M}) | 3 | bits |
| Announcement Counter (AC) | 3 | bits |
| PAGE SCAN Period for Responding Device (PSP_{R}) | 5 | bits |
| PAGE SCAN Repetition Interval for Responding Device | 5 | bits |
| (PSRI_{R}) | | |
| Number of PAGE SCAN Repetitions for Responding Dev. | 2 | bits |
| (NPSR_{R}) | | |
| BD_ADDR₀₋₃₁ of Master Device (BDM₀₋₃₁) | 32 | bits |
| (The 4 highest bits of the UAP of the responding device | 4 | bits) |
| (UAP_{4-7R}) | | |

Similar to Alternative 50, Alternative 51 is applicable only to the master-page-scan-mode-case of the dynamic-single-device-case-scenario. But in Alternative 51, the BDM₀₋₃₁ parameter and the 4 highest bits of the UAP of the responding device (UAP_{4-7R}) are also included. The BDM₀₋₃₁ parameter provides additional topological information to the inquiring device, which is particularly useful when no scatternet identity is used. Including the 4 highest bits of the UAP of the responding device makes it possible to avoid the HEC generation problem during the PAGE procedure.

Alternative 52 (74 available bits)

| | | |
|---|---|---|
| Page Scan Timing Parameter for Responding Device (PST_{M}) | 13 | bits |
| Input to PAGE SCAN Frequency Selection | | |
| Algorithm for Master Device (FSAI_{M}) | 4 | bits |
| Page Scan Mode Parameter for Master Device (PSM_{M}) | 3 | bits |
| BD_ADDR₀₋₂₇ Of Master Device (BDM) | 28 | bits |
| PAGE SCAN Period for Master Device (PSP_{M}) | 1 | bit |
| PAGE SCAN Repetition Interval for Master Device | 1 | bit |
| (PSRI_{M}) | | |
| Number of PAGE SCAN Repetitions for Master Dev. | 1 | bit |
| (NPSR_{M}) | | |
| Spare | 23 | bits |

Alternative 52 includes parameters related to the Scheduled Page Scan Mode of the master device, but none related to the responding device, with the exception of the PSM_{R} parameter, which is placed in the regular PSM parameter. Therefore, this alternative is applicable only to the only-master-information-case of the dynamic-single-device-case-scenario.

As described in Alternative 38, parameters related to the Scheduled Page Scan Mode of the master device are not allowed to vary, neither in presence, nor in size, between matching alternatives of the two-device-case and the only-master-information-case of the dynamic-single-device-case-scenario. The reason for this is that several different slave units can announce the same scheduled PAGE SCAN period of their common master. These announcements may be a mix of announcements using the two-device-case and announcements using the only-master-information-case of the dynamic-single-device-case-scenario. In order for these announcements to provide the same information, the parameters should be the same in all cases.

It is therefore apparent that an alternative designed for the only-master-information-case of the dynamic-single-device-case-scenario has strict requirements on the format of the two-device-case alternative that it is coupled with. This particular alternative has been designed to match Alternative 17 of the two-device-case.

Preferred Alternatives

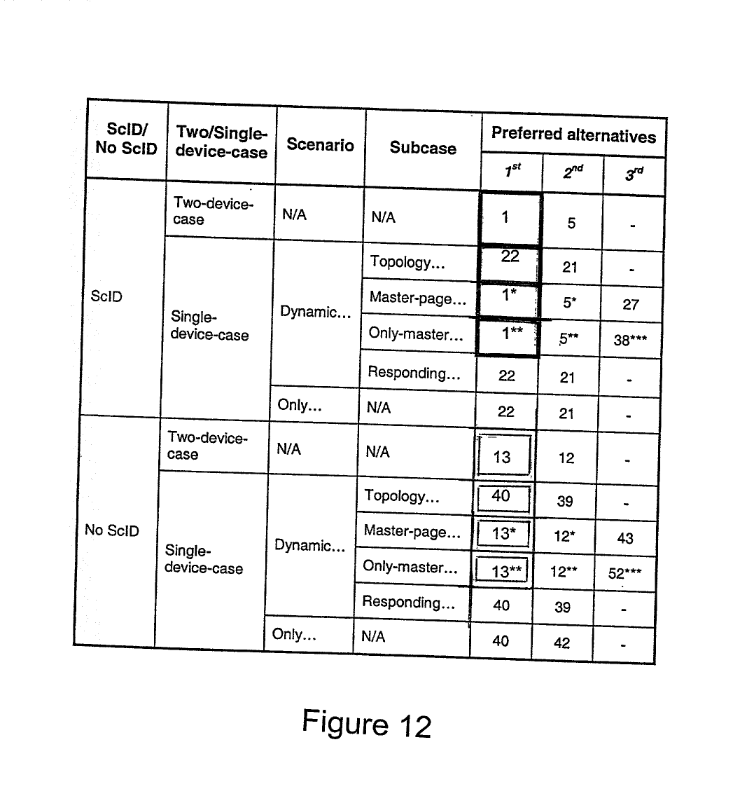

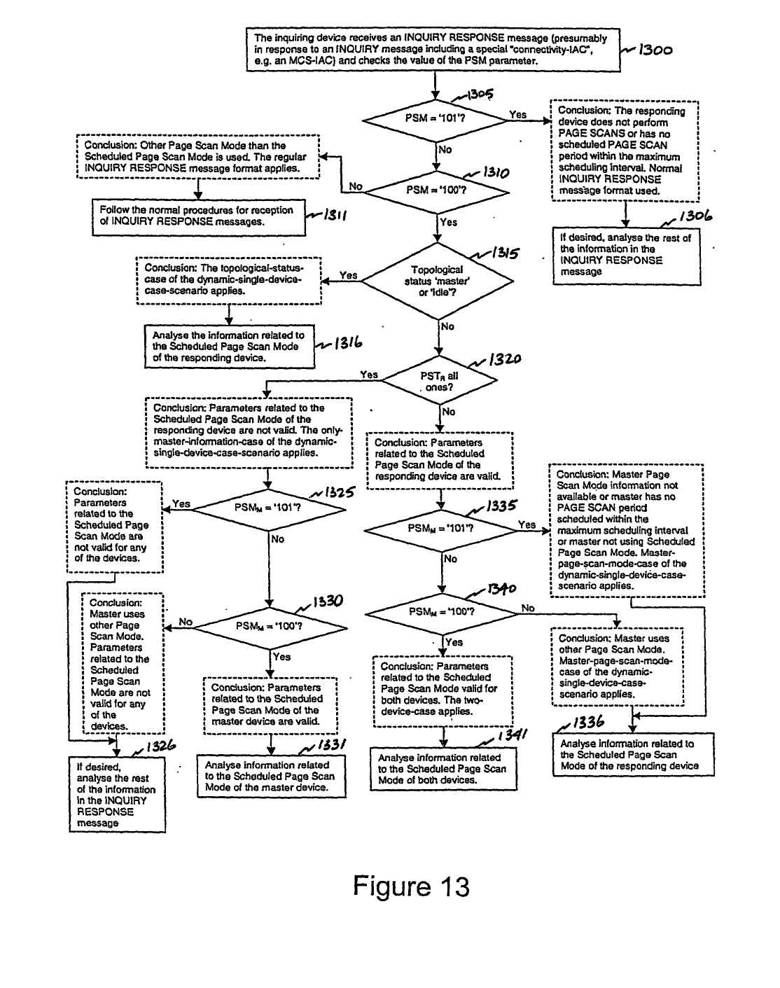

Of the many exemplary alternatives presented above, preferred alternatives for different cases, scenarios and sub-cases may be selected. In addition, one of ordinary skill in the art will recognize that countless other alternatives are possible within the scope of the invention, some of which may be selected. The table of FIG. 12 lists one possible set of preferred alternatives for different cases, scenarios and sub-cases.

The two-device-case is preferable and should be used when possible. It therefore follows that the only-single-device-case-scenario should preferably not be implemented, while the dynamic-single-device-case-scenario may be used as a complement to the two-device-case when the two-device-case is not applicable. However, the responding-page-scan-mode case of the dynamic-single-device-case-scenario should preferably not be used. The resulting preferred combinations are indicated with extra thick table cell borders when a scatternet identity is used and with light double table cell borders when no scatternet identity is used. Between the two groups, the one including the scatternet identity concept (with extra thick table cell borders) is the most preferable.

The single-device-case preferred alternatives marked with a single asterisk use the format of the respective indicated two-device-case alternative with all the scheduled page scan related parameters of the master device unused, except BDM and PSM_{M}. The single-device-case preferred alternatives marked with two asterisks use the format of the respective indicated two-device-case alternative with all the scheduled page scan related parameters of the responding device unused, except PSM_{R}. When the single-device-case preferred alternatives marked with three asterisks are used, the preferred alternatives of the two-device-case cannot be used, since the concerned single-device-case preferred alternatives are specifically matched with other, non-preferred, two-device-case alternatives. However, in this case, a single-device-case alternative can be tailored to resemble either of the preferred two-device-case alternatives.

Furthermore, two of the presently unused values (most significant bit first) of the PSM parameter may be used to specify the PAGE SCAN mode. For example, ‘100’ may specify ‘Scheduled Page Scan Mode’ and ‘101’ may specify either of three modes, depending on the circumstances. They are: 1) ‘Not performing PAGE SCAN’, valid when the concerned device does not perform any PAGE SCANS. 2) ‘No PAGE SCAN scheduled within the maximum scheduling interval’, valid when the concerned device uses the Scheduled Page Scan Mode, but has not scheduled any PAGE SCAN within the duration of the maximum scheduling interval. 3) ‘No PAGE SCAN information available’, valid meaning for the PSM_{M} parameter when the responding device does not know the Page Scan Mode of its master or when it knows that the master uses the Scheduled Page Scan Mode, but the scheduling information is not available.

For the latter of the two values (i.e., ‘101’), the inquiring device can not know which of the three meanings apply, but that does not really matter. The conclusion is the same in all three cases, namely that the concerned device cannot be paged.

The flowchart of FIG. 4 illustrates the procedure followed by an inquiring unit receiving an INQUIRY RESPONSE message in response to an INQUIRY message including a special “connectivity-IAC” according to the preferred alternatives.

When an inquiring device receives an INQUIRY RESPONSE message (step 1300), for example, in response to an INQUIRY message including a special “connectivity-IAC,” with the PSM field set to ‘100’ (step 1310), this indicates that the responding device uses the Scheduled Page Scan Mode. The inquiring device would then check the received topological information (step 1315) and depending on the result it would follow either of the following two procedures.

If the topological information indicates that the responding device is a master device (i.e., only master) or an idle (i.e., unconnected) device (step 1315), the format of the topological-status-case of the dynamic-single-device-case-scenario should be used. The inquiring device analyzes (step 1316) the information related to the Scheduled Page Scan Mode of the responding device according to this format.

If the topological information indicates that the responding device is a slave unit (i.e., only slave or slave and master), either of the formats of the two-device-case, the master-page-scan-mode-case, or the only-master-information-case of the dynamic-single-device-case-scenario should be used. The inquiring device then checks if the PST_{R} parameter is set to all ones (step 1320). If so, the inquiring device concludes that the parameters related to the Scheduled Page Scan Mode of the responding device are not valid and that the only-master-information-case of the dynamic-single-device-case-scenario applies.

The inquiring device then checks if the value of the PSM_{M} parameter is ‘101’ (step 1325). If the PSM_{M} parameter is set to ‘101’, there is no valid scheduling information about the master's PAGE SCANs in the INQUIRY RESPONSE message. The inquiring device may then analyze the remaining information in the INQUIRY RESPONSE message (step 1326). If the value of the PSM_{M} parameter is not ‘101’, the inquiring device checks whether the value of the PSM_{M} parameter is ‘100’ (step 1330). If the value of the PSM_{M} parameter is not ‘100’, the inquiring device concludes that the parameters related to the Scheduled Page Scan mode are not valid for any of the devices (i.e., the responding device and its master). The inquiring device may then analyze the remaining information in the INQUIRY RESPONSE message (step 1326). If the value of the PSM_{M} parameter is ‘100’, the inquiring device concludes that the parameters related to the Scheduled Page Scan Mode of the master device are valid and analyzes this information using the format of the only-master-information-case of the dynamic-single-device-case-scenario (step 1331).

If the inquiring device (in step 1320) determines that the PST_{R} parameter is not set to all ones, it concludes that the parameters related to the Scheduled Page Scan Mode of the responding device are valid. Hence, either of the formats of the two-device-case or the master-page-scan-mode-case of the dynamic-single-device-case-scenario should be used. The inquiring device then checks whether the value of the PSM_{M} parameter is ‘101’ (step 1335). If the PSM_{M} parameter is set to ‘101’, the inquiring device concludes that the parameters related to the Scheduled Page Scan Mode of the master are not valid. The inquiring device then analyzes the information related to the Scheduled Page Scan Mode of the responding device using the format of the master-page-scan-mode-case of the dynamic-single-device-case-scenario (step 1336). If the value of the PSM_{M} parameter is not ‘101’, the inquiring device checks whether the value of the PSM_{M} parameter is ‘100’ (step 1340). If the value of the PSM_{M} parameter is not ‘100’, the inquiring device concludes that the parameters related to the Scheduled Page Scan Mode of the master are not valid. The inquiring device then analyzes the information related to the Scheduled Page Scan Mode of the responding device using the format of the master-page-scan-mode-case of the dynamic-single-device-case-scenario (step 1336). If the value of the PSM_{M} parameter is ‘100’, the inquiring device concludes that the parameters related to the Scheduled Page Scan Mode are valid for both the responding device and its master. The inquiring device then analyzes the information related to the Scheduled Page Scan Mode of both the responding device and its master, applying the format of the two-device-case (step 1341).

Transfer of the Master's PAGE SCAN Scheduling Information

To enable slaves to announce the scheduled PAGE SCAN periods of their master, the master must first transfer the relevant information to its slaves, preferably as soon as the next PAGE SCAN period has been scheduled to give the slaves as much time as possible to announce the scheduled PAGE SCAN period. If the master has tight control of the slaves' INQUIRY SCAN periods, then it is necessary to send the information to the slaves that are scheduled to enter the INQUIRY SCAN state at least once before the master's next scheduled PAGE SCAN period. It is also be possible to transfer information about several scheduled PAGE SCAN periods at the same time, assuming the master has the necessary information far enough in advance.

There are several different possible means for the transfer of this information. One obvious means is in an LMP message. An LMP message could be unicast to each intended slave recipient or broadcast to all the slaves at once (using the all zero AM_ADDR). The broadcast transmission mode preserves bandwidth, but has the disadvantage of not being acknowledged. This is, however, a minor problem, since it is not crucial that the information reaches all the slaves. After all, the purpose of the information is to enable an “optimizing” feature, which may be very useful, but which is not essential for the operation of the Bluetooth system.

Another possible method is to piggyback the scheduling information on a packet used for other purposes, e.g. a user data packet.

In addition to transferring its own Scheduled Page Scan Mode related information to the slaves, one possibility is to let the master also control the Scheduled Page Scan Mode of the slaves. The master would transfer the slave's Scheduled Page Scan Mode related information together with the INQUIRY SCAN scheduling information to each slave. A disadvantage to this possibility is the increased level of control provided to the master.

The Paging Contention Problem

The contention problem may occur when the same scheduled PAGE SCAN period is announced to several inquiring units and more than one of these units decide to PAGE the same device during the same PAGE SCAN period. The paging devices may then interfere with each other, so that, in the worst case, none of them manages to perform a successful PAGE procedure. And even if they do not interfere with each other, because their respective PAGE messages do not overlap, the scanning device may not be able to handle more than one paging device during a single PAGE SCAN period. Some possible solutions to the problem have been described above and are summarized below to provide a better overview of the available methods.

Announcement Counter Solution

The announcement counter parameter is included in the INQUIRY RESPONSE message to indicate how many times the announced PAGE SCAN period has been announced before. That is, the first time information about a certain scheduled PAGE SCAN period is included in an INQUIRY RESPONSE message, the value of the announcement counter is zero. For each subsequent INQUIRY RESPONSE message announcing the same scheduled PAGE SCAN period the announcement counter is increased by one. The announcement counter may be only a single bit, in which case zero indicates that this is the first time the scheduled PAGE SCAN period is announced and one indicates that it has been announced before.

An announcement counter can only be used in conjunction with a scheduled PAGE SCAN period for the responding device, and not in conjunction with a scheduled PAGE SCAN period of the master of the responding device. The reason for this is that several slaves may announce the same scheduled PAGE SCAN period of their common master, thus making it impossible for either one of them to know how many times the PAGE SCAN period has been announced before.

An inquiring device receiving an INQUIRY RESPONSE message including an announcement counter may use this information when determining whether to PAGE the responding device in the announced PAGE SCAN period or not. If the PAGE SCAN period has been announced before, especially if the announcement counter indicates several previous announcements, the inquiring device may choose to PAGE another device or to wait for a less “crowded” PAGE SCAN period to PAGE the responding device.

A flaw of the announcement counter solution is that the responding device does not know to what device it is announcing a scheduled PAGE SCAN period when it responds to an INQUIRY message, since the INQUIRY message does not carry information about the inquiring device. Furthermore, to increase its chances of reaching as many units as possible, an inquiring device will send one or several “trains” of INQUIRY messages on different frequencies. It is quite possible, or even likely depending on how many trains the inquiring unit sends, that a device in the INQUIRY SCAN state responds several times to the same inquiring device. In this situation the announcement counter would be incorrectly increased, since the actual purpose is to indicate the number of inquiring devices that have received announcements—not the number of announcements per se. To partially solve the problem, an inquiring device can keep track of the received values of the announcement counter when it receives subsequent INQUIRY RESPONSE messages from the same device. If the inquiring device determines that the announcement counter is increase by only one each time, it can conclude that the announced PAGE SCAN period has not been announced to any other inquiring device in between. Hence, the first received value of the announcement counter can still be regarded as valid.

Long PAGE SCAN Period Solution

A very simple, but less efficient, solution to the contention problem is to use a long PAGE SCAN period, such as 50 frames. However, this solution reduces one of the benefits of the precise scheduling of the PAGE SCAN period, namely that it requires so little of the scanning device's time and resources.

PAGE SCAN Period Assignment Solution

Interference between different paging devices can be avoided by assigning parts of the same PAGE SCAN period to the different paging devices. This solution requires a longer PAGE SCAN period, as well as a way to assign a specific part of a PAGE SCAN period to a certain device.

The length of the PAGE SCAN period must be increased, so that each assigned part is long enough for a paging device to have a good chance to reach the scanning device with its PAGE message. In addition, due to the PAGE scheduling error, there must be room for some “guard time” between the paging devices. Hence, the required length of the extended PAGE SCAN period depends on the scheduling interval and on the number of paging devices accommodated. A reasonable PAGE SCAN period length is 30 frames, for example.

The assignment of the different parts of a PAGE SCAN period may be accomplished in different ways. One way is to let the value of the announcement counter represent an implicit assignment of a certain part of the associated scheduled PAGE SCAN period. The PAGE SCAN period is divided into 2ⁿ parts, where n is the number of bits in the announcement counter. An inquiring device is assigned the part of the scheduled PAGE SCAN period that is indicated by the value of the announcement counter.

Another way is to derive the part of the PAGE SCAN period to use from the BD_ADDR of each paging device, e.g., by simply looking at the least significant bits. If, for example, the m least significant bits of the BD_ADDR were used as a simple “part indicator”, the PAGE SCAN period is divided into 2^{m} parts. This simple solution works even when no announcement counter is used, but the assignment is not necessarily exclusive, since more than one device with the same m least significant bits of their BD_ADDRs may attempt to PAGE the same device during the same PAGE SCAN period.

Yet another way to assign a part of a PAGE SCAN period is to simply let each paging device randomly select one of a predefined number of parts of the PAGE SCAN period. This solution is also very simple, but still does not necessarily produce exclusive assignments. However, an advantage compared to the method using the BD_ADDR is that, with the random method, a device will choose a new part for each new PAGE SCAN period. Thereby, the risk that two paging devices keep interfering with each other during subsequent PAGE SCAN periods is avoided.

Contiguous PAGE SCAN Period Solution

Separating the paging units in time may also be accomplished by announcing a new PAGE SCAN period to each new inquiring device. However, the responding device does not know whether an inquiry message originates from a new device or from one to which it has already responded. Therefore, the responding device must announce a new PAGE SCAN period in every new INQUIRY RESPONSE message.

The different PAGE SCAN periods are preferably contiguous, to form a single block of PAGE SCAN periods.

Page messages with time jitter or random skips When the PAGE messages of two paging devices interfere with each other, there is a 50% probability that they will continue to do so during the entire PAGE SCAN period. The 50% probability arises because a paging device sends two PAGE messages within one time slot and listens during the next time slot. Interference continues when two devices' first pair of paging messages occur simultaneously, which happens 50% of the times that two paging devices interfere with each other. When one device's second pair interferes with another device's first pair, interference does not occur continually. Instead, only 50% of the messages interfere with each other.

The interference can be avoided by applying a random time jitter to the PAGE message transmissions to break their inherent synchronization with each other. The synchronization between the paging and paged device increases in complexity if this solution is adopted. Another possible solution is to let the paging devices skip randomly selected messages. In either solution, a longer PAGE SCAN period increases the effectiveness of the solution.

It will be appreciated that the steps of the methods illustrated above may be readily implemented either by software that is executed by a suitable processor or by hardware, such as an application-specific integrated circuit (ASIC).

Although described with reference to a communication system, it will be appreciated by those of ordinary skill in the art that this invention can be embodied in other specific forms without departing from its essential character. For example, the invention may be used in any multi-processor system. The embodiments described above should therefore be considered in all respects to be illustrative and not restrictive.

The various aspects of the invention have been described in connection with a number of exemplary embodiments. To facilitate an understanding of the invention, many aspects of the invention were described in terms of sequences of actions that may be performed by elements of a computer system. For example, it will be recognized that in each of the embodiments, the various actions could be performed by specialized circuits (e.g., discrete logic gates interconnected to perform a specialized function), by program instructions being executed by one or more processors, or by a combination of both.

Moreover, the invention can additionally be considered to be embodied entirely within any form of computer readable storage medium having stored therein an appropriate set of computer instructions that would cause a processor to carry out the techniques described herein. Thus, the various aspects of the invention may be embodied in many different forms, and all such forms are contemplated to be within the scope of the invention. For each of the various aspects of the invention, any such form of embodiment may be referred to herein as “logic configured to” perform a described action, or alternatively as “logic that” performs a described action.

It should be emphasized that the terms “comprises” and “comprising”, when used in this specification as well as the claims, are taken to specify the presence of stated features, steps or components; but the use of these terms does not preclude the presence or addition of one or more other features, steps, components or groups thereof.

Various embodiments of Applicants' invention have been described, but it will be appreciated by those of ordinary skill in this art that these embodiments are merely illustrative and that many other embodiments are possible. The intended scope of the invention is set forth by the following claims, rather than the preceding description, and all variations that fall within the scope of the claims are intended to be embraced therein.

What is claimed is:

1. A method for coordinating network nodes in a network, the method comprising the steps of:
informing a first slave node, by a master node, of a first period to scan for inquiry messages;
informing a second slave node, by the master node, of a second period for scanning for inquiry messages, wherein the first period and second period do not occur during a same period of time; and
scanning, by the first slave node, for inquiry messages during the first period, wherein an inquiry message is used by a node sending the inquiry message to determine which nodes are reachable by the node sending the inquiry message.

2. The method of claim 1, wherein the network is a wireless network.

3. The method of claim 2, wherein nodes of the wireless network communicate using frequency hopping.

4. The method of claim 3, wherein the network operates according to Bluetooth protocol.

5. A method for coordinating network nodes in a network, the method comprising the steps of:
informing a first slave node, by a master node, of a first period to send an inquiry message;
informing a second slave node, by the master node, of a second period for sending an inquiry message, wherein the first period and second period do not occur during a same period of time; and
sending, by the first slave node, an inquiry message during the first period, wherein the inquiry message is used by the first node to determine which nodes are reachable by the first node.

6. The method of claim 5, wherein the network is a wireless network.

7. The method of claim 6, wherein nodes of the wireless network communicate using frequency hopping.

8. The method of claim 7, wherein the network operates according to Bluetooth protocol.

9. A method for coordinating establishment of a connection between network nodes in a network, the method comprising the steps of:
sending an inquiry message from a first node to a second node;
sending an inquiry response message from the second node to the first node, wherein the inquiry response message includes page scan information which indicates parameters related to a scanning for page messages by the second node; and
paging from the first node to the second node in accordance with the page scan information.

10. The method of claim 9, wherein the parameters include timing and frequency information related to the scanning for page messages by the second node.

11. The method of claim 9, wherein the parameters include a length of the scan period, a page scan repetition interval and a number of page scan repetitions.

12. The method of claim 9, wherein the parameters include information related to the number of times the page scan information has been distributed.

13. The method of claim 9, wherein the network is a wireless network.

14. The method of claim 9, wherein nodes of the wireless network communicate using frequency hopping.

15. The method of claim 9, wherein the network operates according to Bluetooth protocol.

16. A method for coordinating establishment of a connection between network nodes in a network, the method comprising the steps of:
sending an inquiry message from a first node to a second node;
sending an inquiry response message from the second node to the first node, wherein the inquiry response message includes page scan information which indicates parameters related to a scanning for page messages by a master node associated with the second node; and
paging from the first node to the master node in accordance with the page scan information.

17. The method of claim 16, wherein the parameters include timing and frequency information related to the scanning for page messages by the master node.

18. The method of claim 16, wherein the parameters include a length of the scan period, a page scan repetition interval and a number of page scan repetitions.

19. The method of claim 16, wherein the network is a wireless network.

20. The method of claim 16, wherein nodes of the wireless network communicate using frequency hopping.

21. The method of claim 16, wherein the network operates according to Bluetooth protocol.

22. A method for coordinating network nodes in a network, the method comprising the steps of:
informing a first slave node, by a first master node, of a first period to scan for inquiry messages;
informing a second slave node, by a second master node, of a second period for sending inquiry messages;
scanning by the first slave node for inquiry messages during the first period;
sending an inquiry message by the second slave node during the second period; and
sending an inquiry response message from the first slave node to the second slave node, wherein the inquiry response message includes page scan information that indicates parameters related to a scanning for page messages by the first node.

23. The method of claim 22, further comprising the steps of:
paging from the second slave node to the first slave node in accordance with the page scan information;
responding to the page by the first slave node, thereby establishing a connection between the first slave node and the second slave node.

24. The method of claim 23, wherein the network is a wireless network.

25. The method of claim 23, wherein nodes of the wireless network communicate using frequency hopping.

26. The method of claim 23, wherein the network operates according to Bluetooth protocol.

27. A device for coordinating network nodes in a network, the device comprising:
means for informing a first slave node of a first period to scan for inquiry messages; and
means for informing a second slave node of a second period for scanning for inquiry messages, wherein the first period and second period do not occur during a same period of time;
wherein an inquiry message is used by a node sending the inquiry message to determine which nodes are reachable by the node sending the inquiry message.

28. The device of claim 27, wherein the network is a wireless network.

29. The device of claim 28, wherein the device and nodes of the wireless network all communicate using frequency hopping.

30. The device of claim 29, wherein the network operates according to Bluetooth protocol.

31. A device for coordinating establishment of a connection between network nodes in a network, the device comprising:
means for sending an inquiry message to a node of the network;
means for receiving an inquiry response message from the node at the device, wherein the inquiry response message includes page scan information which indicates parameters related to a scanning for page messages by the node; and
means for paging from the device to the node in accordance with the page scan information.

32. The device of claim 31, wherein the parameters include timing and frequency information related to the scanning for page messages by the node.

33. The device of claim 31, wherein the parameters include a length of the scan period, a page scan repetition interval and a number of page scan repetitions.

34. The device of claim 31, wherein the parameters include information related to the number of times the page scan information has been distributed.

35. The device of claim 31, wherein the network is a wireless network.

36. The device of claim 31, wherein the device and nodes of the wireless network all communicate using frequency hopping.

37. The device of claim 31, wherein the network operates according to Bluetooth protocol.
